(19) United States
(12) Patent Application Publication
(10) Pub. No.: US 2025/0202564 A1
(43) Pub. Date: Jun. 19, 2025

(54) BEAMFORMING RETRO-REFLECTIVE TAG WITH BEAM SELECTION

(71) Applicant: QUALCOMM Incorporated, San Diego, CA (US)

(72) Inventors: Keerthi Priya DASALA, West Lafayette, IN (US); Navid ABEDINI, Basking Ridge, NJ (US)

(21) Appl. No.: 18/539,000

(22) Filed: Dec. 13, 2023

(51) Int. Cl. H04B 7/06; H04B 17/318; H04B 17/336; H04L 5/00

(52) U.S. Cl. CPC H04B 7/06952; H04B 7/0617; H04B 17/328; H04B 17/336; H04L 5/0051

(57) ABSTRACT

Systems and techniques are provided for wireless communications. A network entity can transmit, to a second network entity, information indicative of a request for one or more beam training resources associated with beamforming between the network entity and the second network entity. A downlink-reference signal (DL-RS) repetition corresponding to the request can be received from the second network entity. A respective measurement value associated with the DL-RS on one or more respective beam ports of a plurality of beam ports associated with a beamforming antenna array of the network entity can be determined. Measurement information indicative of one or more of a ranked order of the plurality of beam ports based on the respective measurement values or indicative of the respective measurement values can be transmitted from the network entity to the second network entity.

### FIELD

Aspects of the present disclosure generally relate to wireless communication. In some implementations, examples are described for beam selection for beamforming retro-reflection by a backscatter device.

### INTRODUCTION

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a method of wireless communications is provided. The method comprises: transmitting, to a second network entity, information indicative of a request for one or more beam training resources, the one or more beam training resources associated with beamforming between the network entity and the second network entity; receiving, from the second network entity, a downlink-reference signal (DL-RS) repetition corresponding to the request; determining a respective measurement value associated with the DL-RS on one or more respective beam ports of a plurality of beam ports associated with a beamforming antenna array of the network entity; and transmitting, to the second network entity, measurement information indicative of one or more of a ranked order of the plurality of beam ports based on the respective measurement values or indicative of the respective measurement values.

In another illustrative example, an apparatus for wireless communication is provided. The apparatus includes at least one memory and at least one processor coupled to the at least one memory and configured to: transmit, to a second network entity, information indicative of a request for one or more beam training resources, the one or more beam training resources associated with beamforming between the network entity and the second network entity; receive, from the second network entity, a downlink-reference signal (DL-RS) repetition corresponding to the request; determine a respective measurement value associated with the DL-RS on one or more respective beam ports of a plurality of beam ports associated with a beamforming antenna array of the network entity; and transmit, to the second network entity, measurement information indicative of one or more of a ranked order of the plurality of beam ports based on the respective measurement values or indicative of the respective measurement values.

In another illustrative example, a non-transitory computer-readable storage medium comprising instructions stored thereon which, when executed by at least one processor, causes the at least one processor to: transmit, to a second network entity, information indicative of a request for one or more beam training resources, the one or more beam training resources associated with beamforming between the network entity and the second network entity; receive, from the second network entity, a downlink-reference signal (DL-RS) repetition corresponding to the request; determine a respective measurement value associated with the DL-RS on one or more respective beam ports of a plurality of beam ports associated with a beamforming antenna array of the network entity; and transmit, to the second network entity, measurement information indicative of one or more of a ranked order of the plurality of beam ports based on the respective measurement values or indicative of the respective measurement values.

In another illustrative example, an apparatus is provided for wireless communication. The apparatus includes: means for transmitting, to a second network entity, information indicative of a request for one or more beam training resources, the one or more beam training resources associated with beamforming between the network entity and the second network entity; means for receiving, from the second network entity, a downlink-reference signal (DL-RS) repetition corresponding to the request; means for determining a respective measurement value associated with the DL-RS on one or more respective beam ports of a plurality of beam ports associated with a beamforming antenna array of the network entity; and means for transmitting, to the second network entity, measurement information indicative of one or more of a ranked order of the plurality of beam ports based on the respective measurement values or indicative of the respective measurement values.

According to at least one illustrative example, a method of wireless communications is provided. The method comprises: receiving, from a backscatter device, information indicative of a request for one or more beam training resources, the one or more beam training resources associated with beamforming between the network entity and the backscatter device; transmitting, to the backscatter device, a downlink-reference signal (DL-RS) repetition corresponding to the request; receiving, from the backscatter device, a respective backscattered signal corresponding to a retro-reflection of the DL-RS repetition on each beam port of a configured subset of a plurality of beam ports of the backscatter device; determining a respective measurement value associated with each respective backscattered signal; and transmitting, to the backscatter device, measurement information indicative of one or more of a ranked order of the plurality of beam ports based on the respective measurement values or indicative of the respective measurement values.

In another illustrative example, an apparatus for wireless communication is provided. The apparatus includes at least one memory and at least one processor coupled to the at least one memory and configured to: receive, from a backscatter device, information indicative of a request for one or more beam training resources, the one or more beam training resources associated with beamforming between the network entity and the backscatter device; transmit, to the backscatter device, a downlink-reference signal (DL-RS) repetition corresponding to the request; receive, from the backscatter device, a respective backscattered signal corresponding to a retro-reflection of the DL-RS repetition on each beam port of a configured subset of a plurality of beam ports of the backscatter device; determine a respective measurement value associated with each respective backscattered signal; and transmit, to the backscatter device, measurement information indicative of one or more of a ranked order of the plurality of beam ports based on the respective measurement values or indicative of the respective measurement values.

In another illustrative example, a non-transitory computer-readable storage medium comprising instructions stored thereon which, when executed by at least one processor, causes the at least one processor to: receive, from a backscatter device, information indicative of a request for one or more beam training resources, the one or more beam training resources associated with beamforming between the network entity and the backscatter device; transmit, to the backscatter device, a downlink-reference signal (DL-RS) repetition corresponding to the request; receive, from the backscatter device, a respective backscattered signal corresponding to a retro-reflection of the DL-RS repetition on each beam port of a configured subset of a plurality of beam ports of the backscatter device; determine a respective measurement value associated with each respective backscattered signal; and transmit, to the backscatter device, measurement information indicative of one or more of a ranked order of the plurality of beam ports based on the respective measurement values or indicative of the respective measurement values.

In another illustrative example, an apparatus is provided for wireless communication. The apparatus includes: means for receiving, from a backscatter device, information indicative of a request for one or more beam training resources, the one or more beam training resources associated with beamforming between the network entity and the backscatter device; means for transmitting, to the backscatter device, a downlink-reference signal (DL-RS) repetition corresponding to the request; means for receiving, from the backscatter device, a respective backscattered signal corresponding to a retro-reflection of the DL-RS repetition on each beam port of a configured subset of a plurality of beam ports of the backscatter device; means for determining a respective measurement value associated with each respective backscattered signal; and means for transmitting, to the backscatter device, measurement information indicative of one or more of a ranked order of the plurality of beam ports based on the respective measurement values or indicative of the respective measurement values.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a UE, in accordance with some examples;

FIG. 5 is a diagram illustrating an example of a radio frequency (RF) energy harvesting device, in accordance with some examples;

FIG. 6 is a diagram illustrating an example of backscatter communications performed by an RF backscatter device such as an ambient Internet-of-Things (ambient IoT) tag or device, in accordance with some examples;

FIG. 7 is a diagram illustrating examples of beam steering directions associated with RF beamforming by a beamforming device, in accordance with some examples;

FIG. 8 is a diagram illustrating an example of a Rotman lens that can be used to implement beam learning and/or beam selection for a retro-reflective backscatter device, in accordance with some examples;

FIG. 9 is a diagram illustrating an example of beam selection for a Rotman lens of a retro-reflective backscatter device based on beam sweeping, in accordance with some examples;

FIG. 10 is a flow diagram illustrating an example of a process for wireless communications by a backscatter device, in accordance with some examples;

FIG. 11 is a flow diagram illustrating an example of a process for wireless communications by a network entity, in accordance with some examples; and

FIG. 12 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In various wireless communication networks, various client devices can be utilized that may be associated with different signaling and communication needs. For example, as 5G networks expand into industrial verticals and the quantity of deployed Internet-of-Things (IoT) devices grows, network service categories such as enhanced Mobile Broadband (eMBB), Ultra Reliable Low Latency Communications (URLLC), and massive Machine Type Communications (mMTC), etc., may be expanded to better support various IoT devices, which can include passive IoT devices, semi-passive IoT devices, etc. In some aspects, passive IoT devices may also be referred to as “ambient IoT devices.” An ambient IoT device can be an ambient-power enabled IoT device that is configured to perform RF energy harvesting from an external source of energy (e.g., ambient RF signals, etc.). An “ambient IoT device” may also be referred to as a “tag” and/or a “passive UE” (PUE). In some examples, an ambient IoT device may be an IoT device that can perform ambient energy harvesting. An ambient IoT (AIoT) device may also be referred to as an ambient energy harvesting device and/or a backscatter device.

In some examples, a backscatter device may be implemented as a passive AIoT device that does not include active RF components. In some existing approaches, backscatter devices may be implemented as passive AIoT devices configured to operate in lower frequency bands. In some cases, the AIoT devices implement RF energy harvesting and are configured to perform backscattering for uplink (UL) communications. The AIoT devices may be configured to implement various Rx techniques for receiving downlink (DL) communications, including On-Off Keying (OOK) modulation, various other types of Amplitude Shift Keying (ASK) modulation, and/or envelope tracking, etc.

In some cases, backscatter devices may be configured to operate in lower frequency bands based on challenges of increased isotropic path-loss associated with backscattering and/or energy harvesting performed in higher frequency bands. For instance, the increased isotropic path-loss in the higher frequency bands can correspond to a decreased range of backscattering communications and energy harvesting by the backscatter (e.g., AIoT) device. To achieve a same or similar effective range in the higher frequency bands as in the lower frequency bands, backscatter devices may require the use of beamforming techniques and/or larger BF gains to compensate for the increased isotropic path loss. In some cases, beamforming and larger BF gains are implemented at both the reader device (e.g., a device that transmits an energizing signal and/or receives a backscattered signal) and the tag device (e.g., the backscatter or AIoT device that receives the energizing signal and transmits the backscattered signal).

Conventional beamforming architectures and procedures may be unsuitable for backscatter devices or various other devices that perform energy harvesting and/or backscattering. For instance, many beamforming architectures utilize phased arrays that would exceed a target or design complexity of the relatively low-complexity and low-cost backscatter devices, such as AIoT tags, etc. Beamforming phased arrays may additionally be too costly and/or power intensive for implementation in the low-complexity and low-cost AIoT tags or devices. In some examples, the beamforming techniques associated with performing beamforming using a phased array can be computationally complex and energy intensive, and can be beyond the scope or capabilities of the low-complexity and low-cost AIoT tags or other devices.

There is a need for systems and techniques that can be used to provide backscatter devices (e.g., AIoT tags, etc.) that can perform backscattering and/or energy harvesting in higher frequency bands. There is a further need for systems and techniques that can be used to implement beamforming for backscatter devices configured for operation in higher frequency bands. For example, there is a need for passive beamforming that can be implemented by relatively low-cost and low-complexity AIoT tags or other backscatter devices.

Systems, apparatuses, processes (also referred to as methods), and computer-readable media (collectively referred to as “systems and techniques”) are described herein for radio frequency (RF) beamforming. For instance, the systems and techniques can be used to provide beam learning and/or beam selection for passive beamforming by a backscatter device. In some aspects, the beam learning and/or beam selection can be associated with passive beamformed retro-reflection by a passive or semi-passive backscatter device (e.g., AIoT device, such as an AIoT tag, etc.). In some examples, the systems and techniques for beam learning and/or beam selection can be used to provide beamformed backscattering and/or beamformed energy harvesting in higher frequency bands.

In one illustrative example, passive beamforming for retro-reflection by a backscatter device (e.g., AIoT tag, etc.) can be implemented based on using a Van-Atta or Rotman lens. For instance, an AIoT tag that includes a Van-Atta or Rotman lens can implement passive beamformed retro-reflection without learning beam direction information on the tag-side. In some examples, an AIoT tag can use the Rotman lens to perform passive beamformed retro-reflection that is angle-agnostic to the angle of the incoming signal that is retro-reflected (e.g., reflected in the direction from which the incoming signal originated).

For instance, a backscatter device (e.g., AIoT tag, etc.) with a Rotman lens can have a plurality of beam-ports, where each beam port is provided by the Rotman lens. A Rotman lens can be implemented as a phased array antenna feed that can be used to direct multiple beams simultaneously, without the use of moving or switching components. For instance, the Rotman lens can be configured based on a parallel plate waveguide structure that can form multiple beams based on combining respective signals from multiple input ports (e.g., also referred to as “beam ports”) and directing them to a common set of output ports (e.g., also referred to as “antenna ports” and/or “array ports”). The Rotman lens can be configured to introduce different phase shifts and time delays to the respective signals received at its input ports, where the shifts and delays are configured to form beams in specific directions based on the combination(s) of the beam port signals at the output ports (e.g., antenna ports) of the Rotman lens.

In some aspects, the systems and techniques described herein can be used to learn and select a beam (e.g., from a plurality of beams associated with a Rotman lens) that supports low-power and/or low-cost beamformed backscattering and/or energy harvesting by the backscatter device (e.g., AIoT tag, etc.). In some examples, the beam selection can be used to perform energy harvesting utilizing a selected beam port associated with the main direction of the energizing wave transmitted to the backscatter device. In some cases, energy harvesting utilizing the selected beam port associated with the main direction of the energizing wave can be performed without utilizing DC combining across beam ports, which may otherwise reduce the efficiency of the energy harvesting.

In some examples, the beam selection can be used to perform backscattering by retro-reflecting on the beam port corresponding to the main direction of an energizing signal or other incident signal received by the Rotman lens of the backscatter device. In some aspects, backscattering on a selected beam port of the Rotman lens can improve the efficiency of the backscatter device, as the backscatter device is no longer required to reflect blindly in all directions (e.g., on all beam ports). Backscattering on a selected beam port of the Rotman lens can additionally reduce a power consumption of the backscatter device associated with the backscattering transmission, as one or more switches (e.g., associated with the non-selected beam ports) can remain inactive during the backscattering transmission.

In one illustrative example, a backscatter device with a Rotman lens can include a power detector or other measurement circuitry coupled to each beam port of the plurality of beam ports associated with the Rotman lens. For instance, the backscatter device can measure or determine the received power at each respective beam port of the Rotman lens, based on determining a Reference Signal Receive Power (RSRP) or Reference Signal Strength Indicator (RSSI) value for each respective beam port of the Rotman lens. In some cases, the backscatter device can determine the harvested power and/or DC voltage associated with each respective beam port of the plurality of beam ports of the Rotman lens and/or combinations or subsets thereof.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

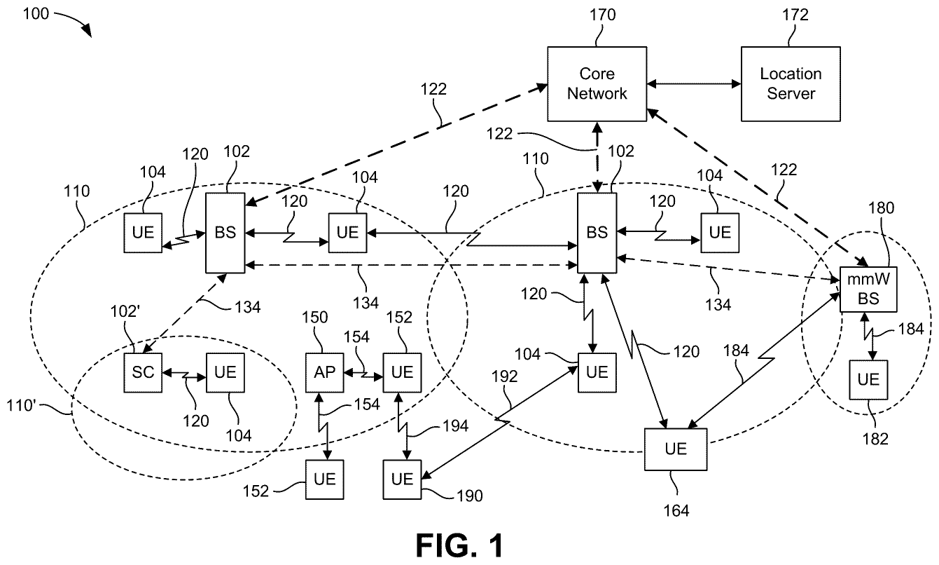

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHZ), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

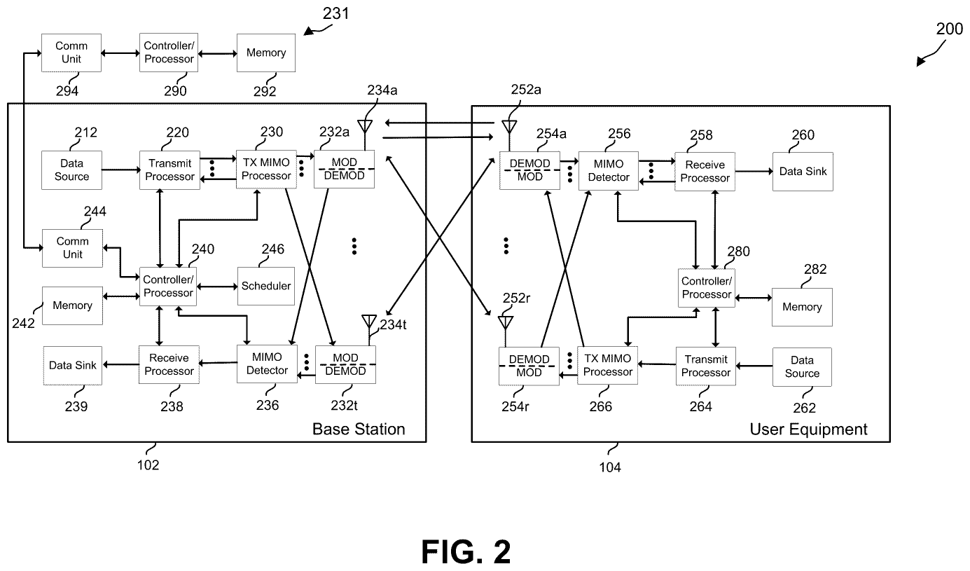

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

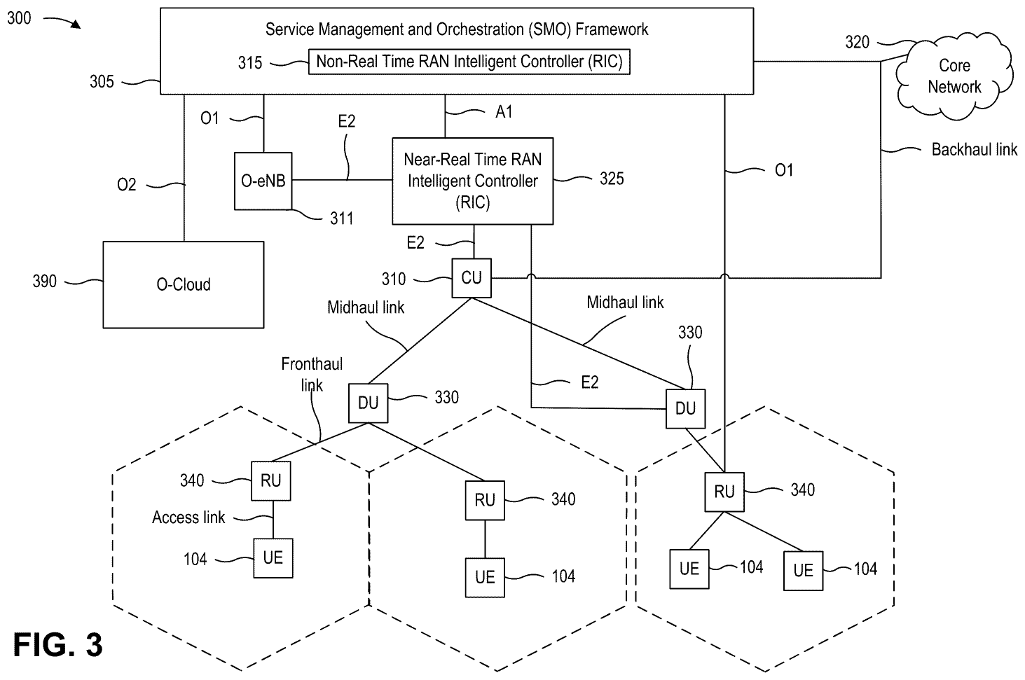

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUS 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via 01) or via creation of RAN management policies (e.g., such as A1 policies).

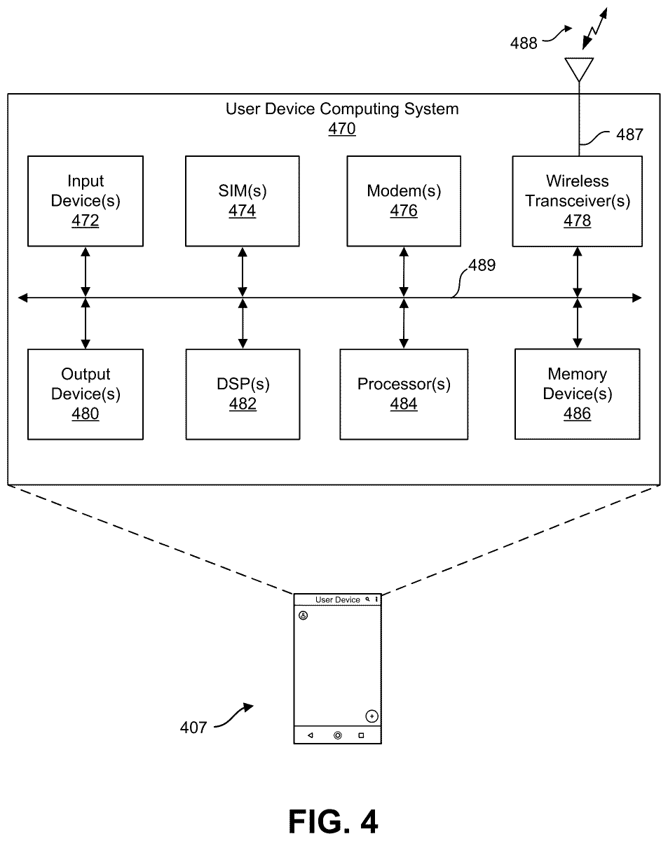

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more central processing units (CPUs), an application specific integrated circuits (ASICs), field programmable logic arrays (FPGAs), application processors (APs), graphics processing units (GPUs), vision processing units (VPUs), neural processing units (NPUs), neural signal processors (NSPs), microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

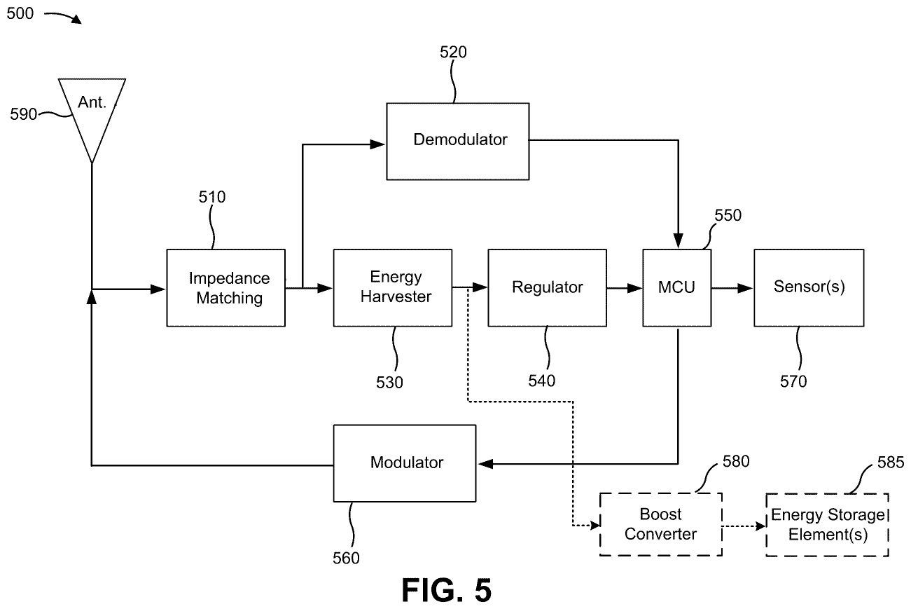

FIG. 5 is a diagram illustrating an example of an architecture of a radio frequency (RF) energy harvesting device 500, in accordance with some examples. In one illustrative example, the RF energy harvesting device 500 can be an ambient IoT (AIoT) device (e.g., the energy harvesting device 500 may also be referred to as AIoT device 500).

As will be described in greater depth below, the energy harvesting device 500 (e.g., AIoT device) can harvest RF energy from one or more RF signals received using an antenna 590. The one or more RF signals received using antenna 590 can be ambient RF signals. For instance, an ambient RF signal can be provided as a dedicated carrier wave (CW) for backscatter modulation by the AIoT device 500. An ambient RF signal can also be provided as an ambient NR signal (e.g., a non-dedicated carrier wave that may still be backscatter modulated by AIoT device 500).

As used herein, the term “energy harvesting” may be used interchangeably with “power harvesting.” In some aspects, AIoT device 500 can be implemented as an Internet-of-Things (IoT) device, can be implemented as a sensor, etc., as will be described in greater depth below. In other examples, AIoT device 500 can be implemented as a Radio-Frequency Identification (RFID) tag or various other RFID devices.

The AIoT device 500 includes one or more antennas 590 that can be used to transmit and receive one or more wireless signals. For example, AIoT device 500 can use antenna(s) 590 to receive one or more downlink signals and to transmit one or more uplink signals. An impedance matching component 510 can be used to match the impedance of antenna(s) 590 to the impedance of one or more (or all) of the receive components included in AIoT device 500. In some examples, the receive components of AIoT device 500 can include a demodulator 520 (e.g., for demodulating a received downlink signal), an energy harvester 530 (e.g., for harvesting RF energy from the received downlink signal), a regulator 540, a micro-controller unit (MCU) 550, and a modulator 560 (e.g., for generating an uplink signal). In some cases, the receive components of AIoT device 500 may further include one or more sensors 570.

The downlink signals can be received from one or more transmitters (e.g., RF sources). For example, AIoT device 500 may receive a downlink signal from a network node or network entity that is included in a same wireless network as the AIoT device 500. In some cases, the network entity can be a base station, gNB, etc., that communicates with the AIoT device 500 using a cellular communication network. For example, the cellular communication network can be implemented according to the 3G, 4G, 5G, and/or other cellular standard (e.g., including future standards such as 6G and beyond).

In some cases, AIoT device 500 can be implemented as a passive or semi-passive energy harvesting device (e.g., an AIoT device), which can perform passive uplink communication by modulating and reflecting a downlink signal received via antenna(s) 590. For example, passive and semi-passive energy harvesting devices may be unable to generate and transmit an uplink signal without first receiving a downlink signal that can be modulated and reflected. In other examples, AIoT device 500 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

An AIoT device (e.g., active or semi-passive energy harvesting device) may include one or more energy storage elements 585 (e.g., collectively referred to as an “energy reservoir”). For example, the one or more energy storage elements 585 can include batteries, capacitors, etc. In some examples, the one or more energy storage elements 585 may be associated with a boost converter 580. The boost converter 580 can receive as input at least a portion of the energy harvested by energy harvester 530 (e.g., with a remaining portion of the harvested energy being provided as instantaneous power for operating the AIoT device 500). In some aspects, the boost converter 580 may be a step-up converter that steps up voltage from its input to its output (e.g., and steps down current from its input to its output). In some examples, boost converter 580 can be used to step up the harvested energy generated by energy harvester 530 to a voltage level associated with charging the one or more energy storage elements 585. An AIoT device (e.g., active or semi-passive energy harvesting device) may include one or more energy storage elements 585 and may include one or more boost converters 580. A quantity of energy storage elements 585 may be the same as or different than a quantity of boost converters 580 included in an active or semi-passive energy harvesting device.

A passive energy harvesting device does not include an energy storage element 585 or other on-device power source. For example, a passive energy harvesting device may be powered using only RF energy harvested from a downlink signal (e.g., using energy harvester 530). As mentioned previously, a semi-passive energy harvesting device can include one or more energy storage elements 585 and/or other on-device power sources. The energy storage element 585 of a semi-passive energy harvesting device can be used to augment or supplement the RF energy harvested from a downlink signal. In some cases, the energy storage element 585 of a semi-passive energy harvesting device may store insufficient energy to transmit an uplink communication without first receiving a downlink communication (e.g., minimum transmit power of the semi-passive device>capacity of the energy storage element). An active energy harvesting device can include one or more energy storage elements 585 and/or other on-device power sources that can power uplink communication without using supplemental harvested RF energy (e.g., minimum transmit power of the active device<capacity of the energy storage element). The energy storage element(s) 585 included in an active energy harvesting device and/or a semi-passive energy harvesting device can be charged using harvested RF energy.

As mentioned above, AIoT devices (e.g., passive and semi-passive energy harvesting devices) transmit uplink communications by performing backscatter modulation to modulate and reflect a received downlink signal. The received downlink signal is used to provide both electrical power (e.g., to perform demodulation, local processing, and modulation) and a carrier wave for uplink communication (e.g., the reflection of the downlink signal). For example, a portion of the downlink signal will be backscattered as an uplink signal and a remaining portion of the downlink signal can be used to perform energy harvesting. A portion of the downlink signal is used as a signal resource for backscattering and a remaining portion of the downlink signal can be used as an energy resource for energy harvesting.

Active energy harvesting devices can transmit uplink communications without performing backscatter modulation and without receiving a corresponding downlink signal (e.g., an active energy harvesting device includes an energy storage element to provide electrical power and includes a powered transceiver to generate a carrier wave for an uplink communication). In the absence of a downlink signal, AIoT devices (e.g., passive and semi-passive energy harvesting devices) may be unable to transmit an uplink signal (e.g., passive communication). Active energy harvesting devices do not depend on receiving a downlink signal in order to transmit an uplink signal and can transmit an uplink signal as desired (e.g., active communication).

In examples in which the energy harvesting device 500 is implemented as an AIoT device (e.g., a passive or semi-passive energy harvesting device), a continuous carrier wave downlink signal may be received using antenna(s) 590 and modulated (e.g., re-modulated) for uplink communication. In some cases, a modulator 560 can be used to modulate the reflected (e.g., backscattered) portion of the downlink signal. For example, the continuous carrier wave may be a continuous sinusoidal wave (e.g., sine or cosine waveform) and modulator 560 can perform modulation based on varying one or more of the amplitude and the phase of the backscattered reflection. Based on modulating the backscattered reflection, modulator 560 can encode digital symbols (e.g., such as binary symbols or more complex systems of symbols) indicative of an uplink communication or data message. For example, the uplink communication may be indicative of sensor data or other information associated with the one or more sensors 570 included in AIoT device 500.

As mentioned previously, impedance matching component 510 can be used to match the impedance of antenna(s) 590 to the receive components of AIoT device 500 when receiving the downlink signal (e.g., when receiving the continuous carrier wave). In some examples, during backscatter operation (e.g., when transmitting an uplink signal), modulation can be performed based on intentionally mismatching the antenna input impedance to cause a portion of the incident downlink signal to be scattered back. The phase and amplitude of the backscattered reflection may be determined based on the impedance loading on the antenna(s) 590. Based on varying the antenna impedance (e.g., varying the impedance mismatch between antenna(s) 590 and the remaining components of AIoT device 500), digital symbols and/or binary information can be encoded (e.g., modulated) onto the backscattered reflection. Varying the antenna impedance to modulate the phase and/or amplitude of the backscattered reflection can be performed using modulator 560.

As illustrated in FIG. 5, a portion of a downlink signal received using antenna(s) 590 can be provided to a demodulator 520, which performs demodulation and provides a downlink communication (e.g., carried or modulated on the downlink signal) to a micro-controller unit (MCU) 550 or other processor included in the AIoT device 500. A remaining portion of the downlink signal received using antenna(s) 590 can be provided to energy harvester 530, which harvests RF energy from the downlink signal. For example, energy harvester 530 can harvest RF energy based on performing AC-to-DC (alternating current-to-direct current) conversion, wherein an AC current is generated from the sinusoidal carrier wave of the downlink signal and the converted DC current is used to power the energy harvesting device 500. In some aspects, energy harvester 530 can include one or more rectifiers for performing AC-to-DC conversion. A rectifier can include one or more diodes or thin-film transistors (TFTs). In one illustrative example, energy harvester 530 can include one or more Schottky diode-based rectifiers. In some cases, energy harvester 530 can include one or more TFT-based rectifiers.

The output of the energy harvester 530 is a DC current generated from (e.g., harvested from) the portion of the downlink signal provided to the energy harvester 530. In some aspects, the DC current output of energy harvester 530 may vary with the input provided to the energy harvester 530. For example, an increase in the input current to energy harvester 530 can be associated with an increase in the output DC current generated by energy harvester 530. In some cases, MCU 550 may be associated with a narrow band of acceptable DC current values. Regulator 540 can be used to remove or otherwise decrease variation(s) in the DC current generated as output by energy harvester 530. For example, regulator 540 can remove or smooth spikes (e.g., increases) in the DC current output by energy harvester 530 (e.g., such that the DC current provided as input to MCU 550 by regulator 540 remains below a first threshold). In some cases, regulator 540 can remove or otherwise compensate for drops or decreases in the DC current output by energy harvester 530 (e.g., such that the DC current provided as input to MCU 550 by regulator 540 remains above a second threshold).

In some aspects, the harvested DC current (e.g., generated by energy harvester 530 and regulated upward or downward as needed by regulator 530) can be used to power MCU 550 and one or more additional components included in the AIoT device 500. For example, the harvested DC current can additionally be used to power one or more (or all) of the impedance matching 510, demodulator 520, regulator 540, MCU 550, sensors 570, modulator 560, etc. For example, sensors 570 and modulator 560 can receive at least a portion of the harvested DC current that remains after MCU 550 (e.g., that is not consumed by MCU 550). In some cases, the harvested DC current output by regulator 540 can be provided to MCU 550, modulator 560, and sensors 570 in series, in parallel, or a combination thereof.

In some examples, sensors 570 can be used to obtain sensor data (e.g., such as sensor data associated with an environment in which the AIoT device 500 is located). Sensors 570 can include one or more sensors, which may be of a same or different type(s). In some aspects, one or more (or all) of the sensors 570 can be configured to obtain sensor data based on control information included in a downlink signal received using antenna(s) 590. For example, one or more of the sensors 570 can be configured based on a downlink communication obtained based on demodulating a received downlink signal using demodulator 520. In one illustrative example, sensor data can be transmitted based on using modulator 560 to modulate (e.g., vary one or more of amplitude and/or phase of) a backscatter reflection of the continuous carrier wave received at antenna(s) 590. Based on modulating the backscattered reflection, modulator 560 can encode digital symbols (e.g., such as binary symbols or more complex systems of symbols) indicative of an uplink communication or data message. In some examples, modulator 560 can generate an uplink, backscatter modulated signal based on receiving sensor data directly from sensors 570. In some examples, modulator 560 can generate an uplink, backscatter modulated signal based on received sensor data from MCU 550 (e.g., based on MCU 550 receiving sensor data directly from sensors 570).

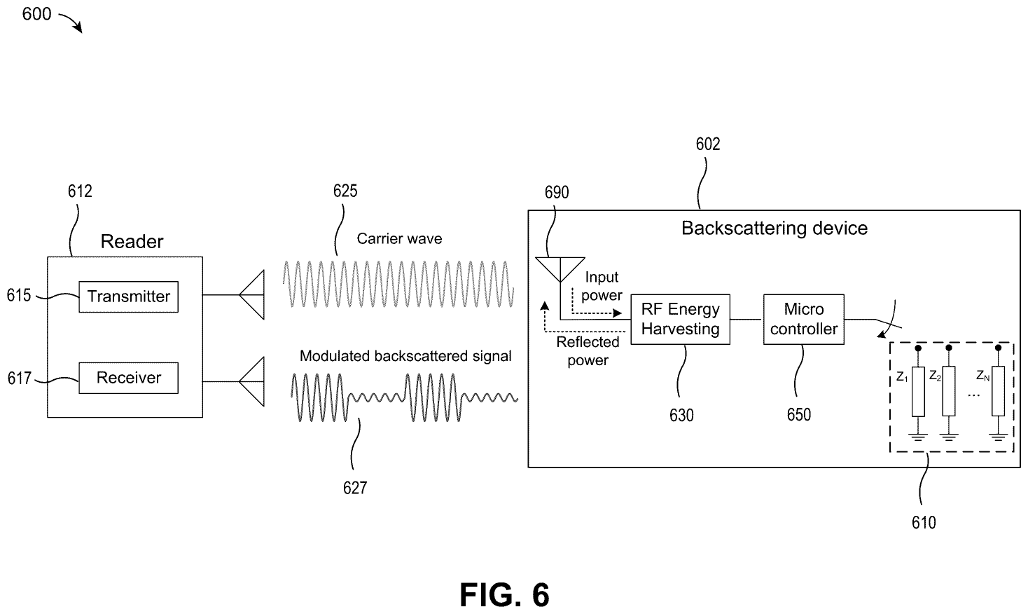

FIG. 6 is a diagram illustrating an example of backscatter communications 600 performed by an RF backscatter device 602. In one illustrative example, the RF backscatter device 602 can be an ambient IoT (AIoT) device, and may also be referred to as “AIoT device 602.” For instance, an AIoT device can be a type of RF backscatter device.

In the example backscatter communications 600, information transmission by AIoT device 602 is performed based on antenna modulation without active RF generation (e.g., at or by AIoT device 602). For instance, the backscatter communications 600 can be performed between AIoT device 602 and a reader device 612. The reader device 612 can be a network entity associated with and/or nearby to the AIoT device 602. For example, reader device 612 can be a base station, gNB, UE, etc.

Reader device 612 can also be referred to as an “RF source” for the backscatter communications 600. For instance, reader device 612 may include a transmitter 615 that is configured to generate a carrier wave (CW) signal 625 that is utilized by AIoT device 602 to perform backscatter communications 602 (e.g., AIoT device 602 can generate a modulated backscattered signal 627 based on or using the incident CW signal 625 from transmitter 615 of reader device 612).

In some aspects, AIoT device 602 of FIG. 6 can be the same as or similar to the AIoT device 500 of FIG. 5. For instance, AIoT device 602 can include an antenna 690 that may be the same as or similar to the antenna 590 of FIG. 5. AIoT device 602 can additionally include an energy harvester 630 that may be the same as or similar to the energy harvester 530 of FIG. 5; may include a micro-controller 650 that may be the same as or similar to the MCU 550 of FIG. 5; may include an impedance matching engine 610 that may be the same as or similar to the impedance matching 510 of FIG. 5; etc.

As noted above, AIoT device 602 can perform backscatter communications 600, where information transmission (e.g., by or from AIoT device 602) is performed based on antenna modulation without active RF generation. For instance, the AIoT device 602 can modulate an incoming RF signal (e.g., CW signal 625) by intentionally switching the load impedance at impedance matching engine 610. The switching of load impedance at impedance matching engine 610 can be configured to vary the amplitude and/or phase of its backscattered signal (e.g., the modulated backscattered signal 627 is modulated based on the varying amplitude and/or phase caused by the switching of load impedance at impedance matching engine 610).

In one illustrative example, AIoT device 602 may implement BPSK modulation (e.g., modulated backscattered signal 627 can be a BPSK modulated signal). The AIoT device 602 can switch the value of the load impedance at impedance matching engine 610 between a relatively high impedance value and a (lower) relatively matched load. In the high impedance switching case, the impedance mismatch between the antenna 690 and the load impedance at impedance matching engine 610 can cause most or all of the incoming RF power (e.g., “input power” at antenna 690, from CW signal 625 to be reflected back to the reader device 612 (e.g., reflected back to the receiver 617 of reader device 612). For instance, when impedance matching engine 610 switches the load impedance to be greater than the antenna 690 impedance, the “input power”=“reflected power” at antenna 690.

In the low impedance switching case, the impedance is approximately matched between antenna 690 and the load impedance at impedance matching engine 610. Based on the approximately matched impedance, most or all of the incoming RF power (e.g., “input power” at antenna 690, from CW signal 625) is absorbed, and very little power is reflected back to the reader device 612 (e.g., reflected back to receiver 617 of reader device 612). For instance, when impedance matching engine 610 switches the load impedance to match the antenna 690 impedance, the “input power”>> “reflected power” at antenna 690. In some aspects, the impedance switching frequency implemented by impedance matching engine 610 can be based on the data rate of the data being modulated onto the modulated backscattered signal 627 by AIoT device 602.

As noted previously, systems and techniques are provided for beam selection at a retro-reflective tag configured to perform backscattering and/or energy harvesting. For instance, beam selection information can be used to perform passive beamformed retro-reflection. Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

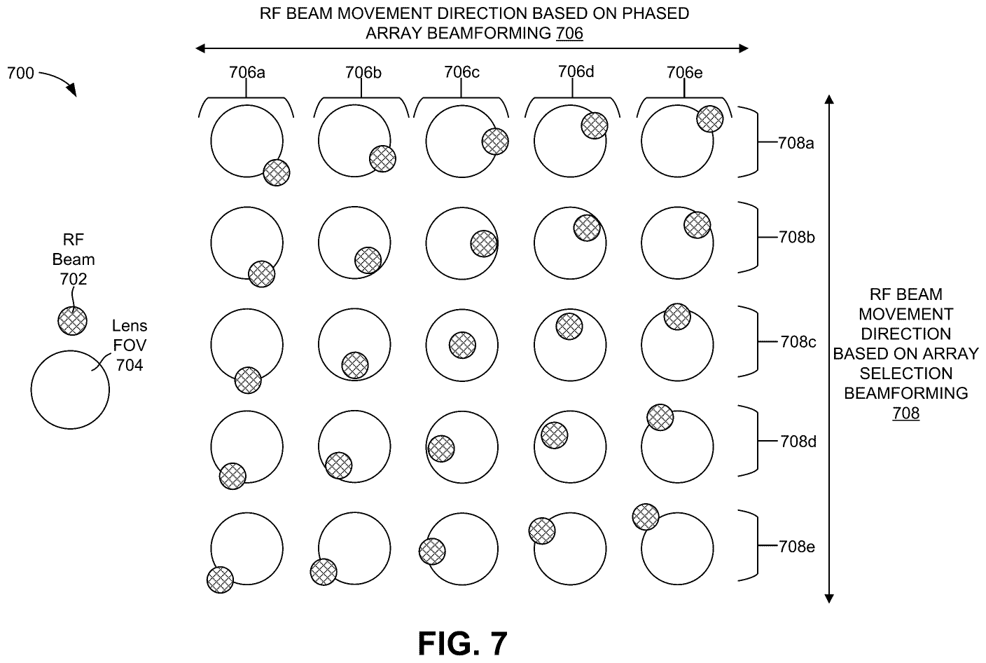

FIG. 7 is a diagram illustrating examples of beam steering directions 700 for an RF beam 702 relative to a lens field of view (FOV) 704. In the example of FIG. 7, a phased linear antenna array can be used to steer an RF beam along a first direction 706 and selection of a linear antenna array can be used to steer an RF beam along a second direction 708. In some aspects, the overall direction of an RF beam can be based the linear antenna array selected for beamforming (e.g., array selection beamforming) and the phasing of the antenna elements within the selected linear antenna array (e.g., phased array beamforming). For example, as illustrated in FIG. 7, movement of the RF beam 702 in a direction 708 (e.g., movement of the RF beam 702 from (706a, 708a) to (706b, 708a)) can be based on the selection of a different linear array using array selection beamforming. For instance, selection of a different antenna array can shift the RF beam 702 in the direction 708. Similarly, movement of the RF beam 702 in a direction 706 (e.g., movement of the RF beam 702 from (706a, 708a) to (706a, 708b)) can be based on phased array beamforming (e.g., using a same antenna array with different antenna phasing). For example, phased array beamforming can shift the RF beam 702 in the direction 706. In one example, the direction of RF beam 702 can be located substantially at the center of lens FOV 704 when array selection beamforming corresponds to linear antenna array 706c and phased array beamforming corresponds to antenna phasing 708c. In another example, the direction of RF beam 702 can be steered away from the center of lens FOV 704 downward along power direction 712 by maintaining antenna phasing 708c and selecting linear antenna array 706b or linear antenna array 706a. In another example, the direction of RF beam 702 can be steered away from the center of lens FOV 704 toward the right along the non-power direction 710 by continuing to use linear antenna array 706c while using antenna phasing 708b or antenna phasing 708a. Similar operations can be performed when using linear antenna array 706d or linear antenna array 706e.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

As noted previously, in some aspects, passive beamforming for retro-reflection by a backscatter device (e.g., AIoT tag, etc.) can be implemented based on using a Van-Atta or Rotman lens. For instance, an AIoT tag that includes a Van-Atta or Rotman lens can implement passive beamformed retro-reflection without learning beam direction information on the tag-side. In some examples, an AIoT tag can use the Rotman lens to perform passive beamformed retro-reflection that is angle-agnostic to the angle of the incoming signal that is retro-reflected (e.g., reflected in the direction from which the incoming signal originated).

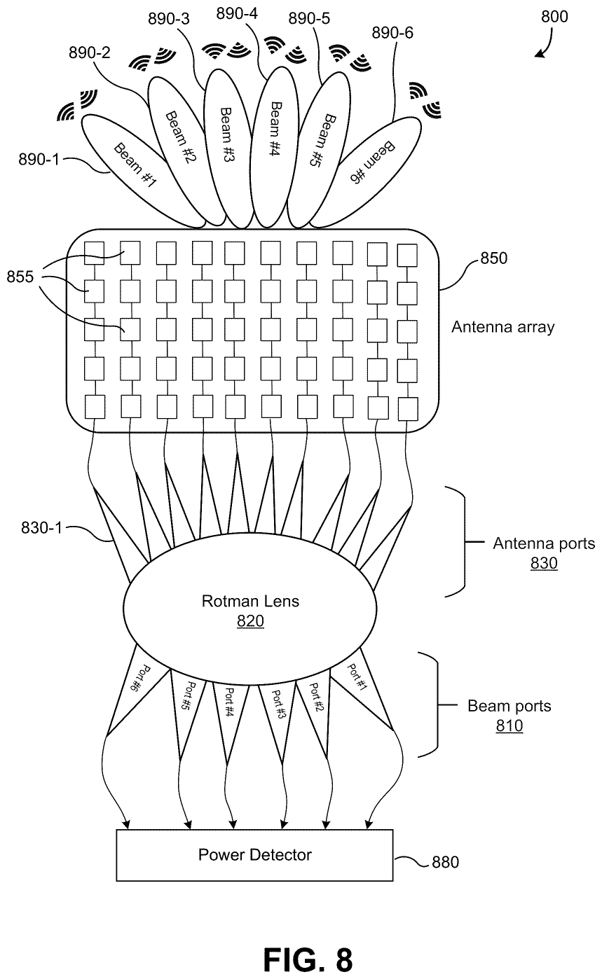

For example, FIG. 8 is a diagram illustrating an example wireless communication system 800 that includes a Rotman lens 820 that may be used to implement beam learning and/or beam selection for a retro-reflective backscatter device, in accordance with some examples. In one illustrative example, the wireless communication system 800 can be implemented by a backscatter device, such as an AIoT tag or other passive or semi-passive AIoT device.

In some aspects, the wireless communication system 800 can be implemented by a backscatter device that is the same as or similar to the backscatter device 500 of FIG. 5. For instance, the Rotman lens 820 and antenna array 850 of FIG. 8 can be included or used to implement the antenna 590 of the backscatter device 500 of FIG. 5. In some cases, the wireless communication system 800 can be implemented by a backscatter device that is the same as or similar to the backscattering device 602 of FIG. 6. For instance, the Rotman lens 820 and antenna array 850 of FIG. 8 can be included in or used to implement the antenna 690 of the backscattering device 602 of FIG. 6.

For instance, the Rotman lens 820 can include and/or be associated with a plurality of beam ports 810, where each beam port is provided by the Rotman lens. In the example of FIG. 8, the Rotman lens 820 is associated with six beam ports, shown as “Port #1”, . . . , “Port #6.” A greater or lesser number of beam ports 810 can also be utilized to implement a Rotman lens such as the Rotman lens 820. As noted previously, the Rotman lens 820 can be used to enable multiple simultaneous beam directions using a single antenna array 850. For instance, the multiple simultaneous beam directions can include one or more (or all) of the respective beam directions associated with the plurality of beams provided by the antenna array 850 (e.g., Beam #1, 890-1; Beam #2, 890-02; Beam #3, 890-3; Beam #4, 890-4; Beam #5, 890-5; Beam #6, 890-6; etc.).

In some aspects, the number of beams included in the plurality of beams 890 associated with the antenna array 850 can be the same as the number of beam ports 810 of the Rotman lens 820. In one illustrative example, the multiple simultaneous beam directions provided by the single antenna array 850 of the Rotman lens 820 can be implemented based on rapid beam steering without mechanical movement. In some aspects, the Rotman lens includes input ports provided by the beam ports 810 (e.g., the beam ports 810 are the input ports of the Rotman lens 820), output ports comprising the plurality of antenna ports 830 of the Rotman lens 820, and a contoured transmission medium connecting the beam ports 810 and the antenna ports 830. In one illustrative example, the Rotman lens 820 of FIG. 8 can be provided as the contoured transmission medium for connecting respective combinations of beam ports 810 with respective antenna ports 830. In some aspects, the number of antenna ports 830 can be greater than the number of beam ports 810 and/or can be greater than the number of beams 890 provided by or associated with the antenna array 850.

In some examples, the Rotman lens 820 can be implemented based on geometrical optics principles. For example, as noted above, the Rotman lens 820 may provide a contoured transmission medium for connecting the beam ports 8120 with the antenna ports 830. In some aspects, the contour of the transmission medium of the Rotman lens 820 can be configured such that the path length from any input port (e.g., any beam port 810) to any output port (e.g., any antenna port 830) is the same, for all combinations of beam ports 810 and antenna ports 830. By configuring the Rotman lens 820 to provide equal path lengths between all beam ports 810 and all antenna ports 830, signals arriving at different output ports (e.g., different antenna ports 830) from a single input port (e.g., a single beam port 810) are phase-aligned, creating a directive beam when fed into the antenna array 850.

The antenna array 850 can comprise a plurality of discrete antenna elements 855, divided into a number of subsets that is equal to the number of antenna ports 830. For instance, each antenna port 830 can be associated with (e.g., coupled to) a corresponding subset of the plurality of discrete antenna elements 855. In some aspects, each antenna port 830 can be coupled to a subset of discrete antenna elements 855 that are connected in series. For instance, the first antenna port 830-1 (e.g., the left-most antenna port 830 of FIG. 8) can be coupled to a subset of discrete antenna elements comprising five respective antenna elements connected in series. A second antenna port (e.g., the second from the left antenna port 830 of FIG. 8, immediately adjacent to the right of antenna port 830-1) can likewise be coupled to a corresponding subset of discrete antenna elements comprising five respective antenna elements connected in series, etc.

In operation of the Rotman lens 820 for transmission, a signal can be fed into one of the beam ports 810 (e.g., one of Port #1, . . . , Port #6). The signal traverses the contoured transmission medium of the Rotman lens 820 and may be radiated from multiple antenna ports 830. Based on the geometry of the Rotman lens 820, the signal undergoes a phase shift across the antenna ports 830, to form a beam in a particular direction when connected to the antenna array 850 (e.g., to form a beam in the direction of one of the plurality of beams 890-1, . . . , 890-6). Based on the selection and/or use of different beam ports 810 for receiving the input signal for transmission by the Rotman lens 820, the direction of the beam can be changed to correspond to a selected one of beams 890-1, . . . , 890-6 without the use of moving parts for implementing the Rotman lens 820.

In one illustrative example, the Rotman lens 820 can be implemented as a phased array antenna feed that can be used to direct multiple beams (e.g., beams 890-1, . . . , 890-6) simultaneously, without the use of moving or switching components. For instance, the Rotman lens 820 can be configured based on a parallel plate waveguide structure that can form multiple beams based on combining respective signals from multiple input ports 810 (e.g., also referred to as “beam ports”) and directing them to a common set of output ports 830 (e.g., also referred to as “antenna ports” and/or “array ports”). The Rotman lens 820 can be configured to introduce different phase shifts and time delays to the respective signals received at its input beam ports 810, where the shifts and delays are configured to form beams in specific directions based on the combination(s) of the beam port 810 signals at the output ports 830 (e.g., antenna ports) of the Rotman lens 820.

In some aspects, the systems and techniques described herein can be used to learn and select a beam (e.g., from a plurality of beams 890-1, . . . , 890-6 associated with the Rotman lens 820) that supports low-power and/or low-cost beamformed backscattering and/or energy harvesting by the backscatter device (e.g., AIoT tag, etc.) that includes the Rotman lens 820. In some examples, the beam selection can be used to perform energy harvesting utilizing a selected beam port 810 associated with the main direction of the energizing wave transmitted to the backscatter device. In some cases, energy harvesting utilizing the selected beam port 810 associated with the main direction of the energizing wave can be performed without utilizing DC combining across beam ports, which may otherwise reduce the efficiency of the energy harvesting.

In some examples, the beam selection can be used to perform backscattering by retro-reflecting on the beam port 810 corresponding to the main direction of an energizing signal or other incident signal received by the Rotman lens 820 of the backscatter device. In some aspects, backscattering on a selected beam port 810 of the Rotman lens 820 can improve the efficiency of the backscatter device, as the backscatter device is no longer required to reflect blindly in all directions (e.g., on all beam ports 810). Backscattering on a selected beam port 810 of the Rotman lens 820 can additionally reduce a power consumption of the backscatter device associated with the backscattering transmission, as one or more switches (e.g., associated with the non-selected beam ports) can remain inactive during the backscattering transmission.

In one illustrative example, a backscatter device with a Rotman lens 820 can include a power detector 880 or other measurement circuitry coupled to each beam port of the plurality of beam ports 810 associated with the Rotman lens 820. For instance, each beam port of the plurality of beam ports 810 can be coupled to the same power detector 880. In some examples, multiple power detectors 880 can be coupled to corresponding subsets of the beam ports 810, where the combination of the multiple power detectors 880 is configured to provide power information for each respective beam port of the plurality of beam ports 810.

In some aspects, a backscatter device can measure or determine the received power at each respective beam port (e.g., Port #1, . . . , Port #6) of the plurality of beam ports 810 of the Rotman lens 820, based on determining a Reference Signal Receive Power (RSRP) or Reference Signal Strength Indicator (RSSI) value for each respective beam port of the plurality of beam ports 810 of the Rotman lens 820. In some cases, the backscatter device can determine the harvested power and/or DC voltage associated with each respective beam port of the plurality of beam ports 810 of the Rotman lens 820 and/or combinations or subsets thereof.

For instance, the power detector 880 can be used to determine a received power (e.g., RSRP, RSSI, etc.) at each beam port 810 corresponding to a received signal or downlink signal received by the antenna array 850 on one or more of the plurality of beams 890-1, . . . , 890-6 (e.g., collectively referred to as the plurality of beams 890). For instance, the received signal can be a downlink signal transmitted by a network entity (e.g., gNB, base station, etc.) associated with the backscatter device implementing the Rotman lens 820. In some aspects, the received signal can be a reference signal. In some examples, the received signal can be transmitted by (e.g., can be received at the antenna array 850 from) a reader device or transmitter device that is the same as or similar to the reader device 612 of FIG. 6 and/or that includes at least the transmitter 615 of FIG. 6. For instance, the received signal at the antenna array 850 associated with the Rotman lens 820 may be an energizing signal or carrier wave, the same as or similar to the carrier wave 625 transmitted to the antenna 690 of the backscattering device 602 of FIG. 6.

The process for receiving a signal using the Rotman lens 820 of FIG. 8 can be the reverse of the process noted above for transmitting a signal using the Rotman lens 820 of FIG. 8. The received signal (e.g., reference signal, energizing signal, carrier wave, etc.) can be received on one or more of the plurality of beams 890 and coupled into the antenna array 850 and/or the plurality of discrete antenna array elements 855. From the antenna array 850, the received signal is provided to the respective antenna ports 830. The received signal can be provided to some, or all, of the respective antenna ports 830, with the same or different received powers or signal strength values. From the antenna ports 830, the received signal(s) propagate through and traverse the geometry of the Rotman lens 820, to reach the beam ports 810 with the configured phase shift(s) of the Rotman lens 820 geometry applied to the respective signal components from the antenna ports 830. The power detector 880 can be configured to determine which beam ports of the plurality of beam ports 810 receive a signal component corresponding to the downlink or reference signal received using the antenna array 850 (e.g., which beam ports 810 receive a non-zero signal component). The power detector 880 can additionally be configured to determine the received power on these beam ports 810 (e.g., RSSI, RSRP, etc.). Based on the beam ports 810 that receive a signal component based on the downlink signal at the antenna array 850, and based on the respective received power at each of these beam ports 810, the backscatter device including the Rotman lens 820 can utilize the received power information (e.g., RSSI, RSRP, etc.) to determine the one or more beams corresponding to the downlink signal at the antenna array 850 (e.g., to determine the respective beams 890 corresponding to the downlink signal, or the respective beams used for the downlink signal, etc.).

In one illustrative example, the backscatter device can analyze the received power information from the power detector 880 to perform beam learning and/or beam selection. For instance, the backscatter device can use the power information from the power detector 880 to learn a relevant beam port 810 to utilize for a corresponding energy harvesting and/or backscattering that will be performed by the backscatter device responsive to the downlink signal received at the antenna array 850.

For instance, for energy harvesting by the backscatter device, the downlink signal received by the antenna array 850 can be an energizing signal or waveform that can be provided to an energy harvester the same as or similar to the energy harvester 530 of the backscatter device 500 of FIG. 5 and/or the RF energy harvesting engine 630 of the backscatter device 602 of FIG. 6, etc. In one illustrative example, for energy harvesting by the backscatter device, the power detector 880 can be used to learn a relevant beam port (e.g., of the plurality of beam ports 810), where the relevant beam port is the beam port 810 corresponding to the particular beam 890 associated with the main direction of the energy source that transmitted the energizing signal to the antenna array 850. For example, the learned beam port 810 for energy harvesting can be the particular beam port (e.g., of the plurality of beam ports 810) corresponding to the beam (e.g., of the plurality of beams 890-1, . . . , 890-6) with the largest received power, as the beam with the largest RSRP, RSSI, or other received power measurement is likely the beam that is most closely aligned with the direction or angle formed between the antenna array 850 and the energizing device (e.g., network entity such as a base station, gNB, etc.).

As noted previously above, based on learning the relevant beam port 810 for energy harvesting (e.g., beam port 810 with the greatest received power, RSRP, RSSI, etc.), the backscatter device including the Rotman lens 820 can be configured to perform energy harvesting without implementing DC combining across the plurality of beam ports 810. For instance, if beam port #3 is learned as the relevant beam port with the greatest received power, RSSI, or RSRP (e.g., as measured by the power detector 880), the backscatter device can be configured to perform energy harvesting using only beam port #3, and any signal or power received on the remaining beam ports #1, #2, #4, #5, and #6 may be ignored or otherwise not utilized for DC combining. In this example, energy harvesting is performed only from the signal received and output on beam port #3, without performing any DC combining or otherwise utilizing any signal contribution from the remaining beam ports #1, #2, #4, #5, #6 of the Rotman lens 820. Performing energy harvesting by the backscatter device based on using only the learned beam port (e.g., beam port #3 in this example) corresponding to the greatest received power (e.g., RSRP, RSSI, etc.) can reduce the complexity of the backscatter device and can improve the efficiency of energy harvesting by the backscatter device, both based on the backscatter device not performing DC combining across the plurality of beam ports 810.

In some aspects, the backscatter device including the Rotman lens 820 can additionally, or alternatively, be configured to perform backscattering communications based on and using a downlink signal received at the antenna array 850 on one or more of the plurality of beams 890. For instance, the backscatter device can use the power detector 880 to learn the one or more beam ports 810 corresponding to the largest received power (e.g., RSSI, RSRP, etc.) of an energizing signal or carrier wave received by the antenna array 850 for backscatter communications. The beam port 810 with the largest received power measured by the power detector 880 can be the beam port 810 corresponding to a particular one of the plurality of beams 890-1, . . . , 890-6 that is aligned or most closely aligned with a beam used for the downlink energizing signal or carrier wave. In one illustrative example, the backscatter device including the Rotman lens 820 can be configured to perform backscatter modulation and transmit a backscatter modulated signal using the beam port 810 and beam 890 corresponding to the learned (e.g., largest) receive power.

In one illustrative example, the backscatter device including the Rotman lens 820 can be configured to learn or otherwise utilize a first beam port of the plurality of beam ports 810 to perform energy harvesting and may learn or otherwise utilize a second beam port of the plurality of beam ports 810 to perform backscattering, where the first and second beam ports are different. For instance, the backscatter device can learn and use beam port #3 to perform energy harvesting (e.g., corresponding to a downlink energizing signal received on or associated with beam #3 890-3), and may learn and use beam port #2 to perform backscattering (e.g., corresponding to a downlink carrier wave signal received on or associated with beam #2 890-2).

In some aspects, the downlink signal received and used to perform energy harvesting can be different from the downlink signal received and used to perform backscattering. In the example above, the signals received on beams 890-2 and 890-3 can be different from one another. In some aspects, the downlink signal received and used to perform energy harvesting can be the same as the downlink signal received and used to perform backscattering. For instance, a respective portion of the same downlink signal can be received on multiple beams of the plurality of beams 890, and the respective portions can be used to perform energy harvesting or backscattering.

In some aspects, the backscatter device can be configured to perform energy harvesting using the beam port 810 and beam 890 having the largest received power measured by the power detector 880, and backscattering can be performed using the beam port 810 and beam 890 having the second largest received power, etc. In another example, the backscatter device can be configured to perform backscattering communications using the beam port 810 and beam 890 having the largest received power measured by the power detector 880, and energy harvesting can be performed using the beam port 810 and beam 890 having the second largest received power, etc.

In one illustrative example, the systems and techniques described herein can be configured to learn and select the best one or more beam port(s) of the plurality of beam ports 810 associated with a Rotman lens 820 implemented by an AIoT tag or other backscatter device. For instance, assuming a fixed position or relatively slow-moving tag (e.g., such that the relative angle or beam between the antenna array 850 and a network entity transmitting downlink signals to the antenna array 850 is relatively unchanged between successive downlink transmission by the network entity), the backscatter device can learn and select the one or more best beam port(s) of the plurality of beam ports 810 based on the received power information measured by the power detector 880, as described above.

For instance, the backscatter device can use the power detector 880 to measure the received power (e.g., RSRP, RSSI, etc.) at each respective beam port of the plurality of beam ports 810. In some aspects, the backscatter device can measure or determine a harvested power on each respective beam port of the plurality of beam ports 810 (e.g., a harvested power on each respective beam port, obtained by an RF energy harvester of the backscatter device). In some cases, the backscatter device can use the power detector 880 to measure or determine a DC voltage on each respective beam port of the plurality of beam ports 810, and/or on various combinations of the plurality of beam ports 810.

In some examples, the backscatter device can be configured to sweep over beam ports and/or groups or subsets of the plurality of beam ports 810 to obtain respective received power measurements for each beam port, corresponding to one or more downlink signals received at the antenna array 850.

In one illustrative example, the backscatter device can transmit a request to a network entity (e.g., base station, gNB, etc.) for beam training resources. For instance, the backscatter device can indicate a requested quantity of beam training resources to the network entity. In some aspects, the backscatter device can indicate to the network entity a repetition of downlink reference signal (DL RS) resources, such as channel state information-reference signal (CSI-RS) needed or requested by the backscatter device for performing the beam learning and/or selection associated with the beams 890 of the Rotman lens 820.

In some aspects, the network entity (e.g., gNB, base station, etc.) can indicate to the backscatter device configuration information indicative of a beamforming configuration and/or indicative of a beam-sweeping configuration that will be used for or is associated with downlink communications from the network entity to the antenna array 850/the backscatter device. For instance, the configuration information from the network entity can be indicative of the particular set of beam ports (or groups of beam ports) of the plurality of beam ports 810 that should be measured by the backscatter device using the power detector 880.

In some examples, the network entity can transmit the configuration information to the backscatter device, based on previously receiving capability information from the backscatter device, where the capability information is indicative of one or more supported beamforming configurations of the backscatter device. For instance, the capability information can be transmitted by the backscatter device to the network entity, and may be indicative of a type of Rotman lens 820, a number of beam ports 810, a number of antenna ports 830, a type of antenna array 850, a number of beams 890, and/or various configuration information corresponding to the connections and paths between the beams 890, antenna ports 830, and beam ports 810.

In some aspects, the backscatter device can be configured to transmit measurement information to the network entity (e.g., gNB, base station, etc.), where the measurement information is indicative of the received power (e.g., RSSI, RSRP, etc.) and/or harvested power and/or DC voltage measured by the power detector 880 for each beam port or group of beam ports of the plurality of beam ports 810. Based on the measurement information received from the backscatter device, the network entity can subsequently determine scheduling information and/or beamforming configuration information for transmitting one or more downlink signals to the antenna array 850 of the backscatter device (e.g., using a configured one or more of the beams 890) for performing energy harvesting and/or backscattering by the backscatter device.

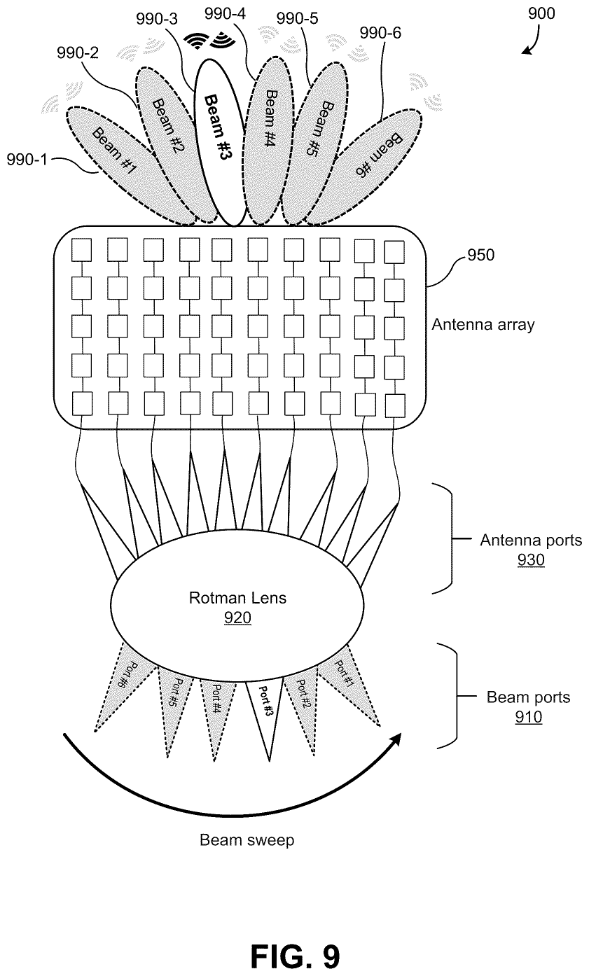

In some examples, an AIoT tag or other backscatter device may implement and include a Rotman lens without a power detector 880 or received power measurement capabilities. For instance, FIG. 9 is a diagram illustrating an example of beam learning and selection 900 for a Rotman lens of a retro-reflective backscatter device based on beam sweeping, in accordance with some examples.

In one illustrative example, the Rotman lens 920 of FIG. 9 can be the same as or similar to the Rotman lens 820 of FIG. 8. For instance, the plurality of beam ports 910 of FIG. 9 can be the same as or similar to the plurality of beam ports 810 of FIG. 8. The plurality of antenna ports 930 of FIG. 9 can be the same as or similar to the plurality of antenna ports 830 of FIG. 8. The antenna array 950 of FIG. 9 can be the same as or similar to the antenna array 850 of FIG. 8. The plurality of beams 990 of FIG. 9 (e.g., beams 990-1, 990-2, 990-3, 990-4, 990-5, 990-6) can be the same as or similar to the plurality of beams 890 of FIG. 8 (e.g., beams 890-1, 890-2, 890-3, 890-4, 890-5, 890-6, respectively).

In some aspects, a backscatter device implementing the Rotman lens 920 without received power measurement capabilities (e.g., without a power detector such as the power detector 880 of FIG. 8, etc.) can be configured to transmit a request for DL-RS repetition to a network entity (e.g., base station, gNB, etc.). In one illustrative example, the backscatter device can transmit the request to the network entity for DL-RS repetition, and can subsequently receive the DL-RS repetition (e.g., a repeated downlink reference signal transmitted by the network entity) using the antenna array 950. The backscatter device can be configured to perform beam sweeping and/or otherwise sweep over each respective beam port of the plurality of beam ports 910 associated with the Rotman lens 920 and backscatter the respective portion of the DL-RS repetition received on the respective beam port.

For instance, the backscatter device can transmit a request to the network entity for DL-RS repetition, and may subsequently sweep over beam ports #6-#1 (or vice versa, or in various other orders, etc.) to backscatter (e.g., retro-reflect) back to the network entity the respective portion of the DL-RS repetition that was received by the backscatter device on the respective one of the beam ports #6-#1. In some examples, each repetition of the DL-RS transmitted by the network entity and received by the antenna array 950 of the backscatter device can be used to perform backscattering and/or retro-reflection for a different beam port of the plurality of beam ports 910 associated with the sweeping performed by the backscatter device. For instance, six repetitions of the DL-RS transmitted by the network entity can be used by the backscatter device to perform backscattering or retro-reflection for each respective beam port of the plurality of beam ports 910 (e.g., each respective beam port of the six beam ports #6-#1).

In some aspects, the network entity can receive the respective backscatter transmission retro-reflected by the backscatter device on each respective beam port of the plurality of beam ports 910, and can measure or determine the respective received power (e.g., RSSI, RSRP, etc.) information corresponding to each respective beam port of the plurality of beam ports 910.

In some examples, the network entity can indicate a beamforming configuration or a beam sweeping configuration to the AIoT tag or other backscatter device including the Rotman lens 920. Based on the indicated beamforming configuration or beam sweeping configuration, the AIoT tag or backscatter device can determine a configured subset of beam ports and/or groups of beam ports of the plurality of beam ports 910 to sweep over. In some examples, the network entity can transmit the configuration information to the backscatter device, based on previously receiving capability information from the backscatter device, where the capability information is indicative of one or more supported beamforming configurations of the backscatter device. For instance, the capability information can be transmitted by the backscatter device to the network entity, and may be indicative of a type of Rotman lens 920, a number of beam ports 910, a number of antenna ports 930, a type of antenna array 950, a number of beams 990, and/or various configuration information corresponding to the connections and paths between the beams 990, antenna ports 930, and beam ports 910.

In some aspects, the network entity can be configured to perform measurements of the backscattered signals transmitted by the backscatter device on the various beam ports 910 configured for the beam sweeping process. In one illustrative example, the network entity can perform multiple measurements of the backscattered signals on multiple occasions. For instance, DL-RS repetition can be performed until the network entity has received a configured number of backscattered signals on each configured beam port 910 and/or until the network entity has determined a configured number of measurements for the backscattered signals on each configured beam port 910.

In some examples, the network entity can transmit measurement information to the AIoT tag or backscatter device that includes the Rotman lens 920, where the measurement information transmitted by the network entity is indicative of the results of the beam sweeping backscatter measurements. For instance, the network entity can transmit measurement information to the backscatter device where the measurement information is indicative of a sorted or ranked order of the plurality of beam ports 910 according to a measured metric determined by the network entity. The listing of the plurality of beam ports 910 indicated in the measurement information from the network entity can be in an ascending or descending ranked order, based on the measured metric utilized by the network entity. For instance, the measured metric can be RSRP, signal-to-noise ratio (SNR), signal-to-interference-to-noise ratio (SINR), etc. Based on the ranked order of the plurality of beam ports 910 received in the measurement information from the network entity, the backscatter device can perform energy harvesting and/or backscatter communications using a learned one or more beam ports 910 that are most aligned with the beam(s) 990 utilized by the network entity for downlink transmissions to the antenna array 950 of the backscatter device. In some aspects, the measurement information from the network entity to the backscatter device is indicative of only the ranked order of the plurality of beam ports. In some cases, the measurement information from the network entity to the backscatter device can be additionally indicative of the measurement metric used and/or the respective value of the measurement metric for each respective beam port of the plurality of beam ports 910 in the ranked order listing.

In some aspects, the network entity (e.g., gNB, base station, etc.) can utilize the measurement information to perform scheduling of downlink transmissions to the backscatter device for energy harvesting and/or backscattering communications, where the scheduled downlink transmissions utilize the one or more learned beams (e.g., of the plurality of beams 990) having the best measurement metric values and/or the one or more learned beams from the top of the ranked order indicated to the backscatter device in the measurement information transmitted previously by the network entity. In some cases, the network entity can utilize the measurement information to determine or otherwise generate a beamforming configuration for downlink transmissions from the network entity to the backscatter device, where the beamforming configuration and downlink transmissions are associated with energy harvesting and/or backscatter communications performed by the backscatter device using the one or more learned beams and corresponding beam ports indicated at the top of the ranked order of the listing included in the measurement information transmitted from the network entity to the backscatter device.

In some cases, the backscatter device and/or the network entity associated with the backscatter device can determine the beam port measurement information based on implementing an efficient beam search. For instance, the efficient beam search can be implemented as a binary search. In one illustrative example, the efficient beam search can start with two combined beams (e.g., each comprising N/2 beam ports, where N is equal to the number of beam ports in the plurality of beam ports 810 of FIG. 8 or 910 of FIG. 9 (e.g., six)).

In the first iteration of the binary search, the best combined beam can be selected between the first combined beam comprising the first set of N/2 beam ports and the second combined beam comprising the second set of N/2 beam ports. For instance, the first iteration can select the best combined beam between a first combined beam comprising the combination of the 6/2=3 beams corresponding to beam ports #1, #2, #3 and a second combined beam comprising the combination of the 6/2=3 beams corresponding to beam ports #4, #5, #6. The selected best combined beam can be sub-divided to create two beams each including N/4 beam ports, etc., until no further division is possible and the selection is between two non-combined beams (e.g., until the selection is between two individual beam ports included in the plurality of beam ports 910, etc.).

In some aspects, where the AIoT tag or backscatter device includes a power detector (e.g., such as the power detector 880 of FIG. 8) or is otherwise configured to obtain the beam or beam port measurement information itself, the backscatter device can be configured to determine which beam ports of the plurality of beam ports 810 to utilize for the measurements. For instance, the backscatter device can determine which beam ports to use for the measurements based on the results of prior measurements performed by the backscatter device and utilizing one or more of the plurality of beam ports 810. In some cases, the backscatter device can transmit information indicative of a requested minimum processing time gap between the respective DL-RS resources of the DL-RS repetition also requested by the backscatter device from the network entity. For example, the DL-RS resources of the DL-RS repetition may include K groups of M consecutive DL-RS resources, with a time gap greater than or equal to d between the consecutive groups (e.g., K=log 2(N), where M=2, d=one or more symbols, and N=total number of beam ports to search over).

In some cases, the systems and techniques can implement signaling from the AIoT tag or backscatter device to the network entity, and/or can implement signaling from the network entity to the AIoT tag or backscatter device. For instance, the signaling between the backscatter device and the network entity can be configured to share information associated with configuring the beam search parameters, and/or the signaling between the backscatter device and the network entity can be used to share information associated with a resource configuration (e.g., DL-RS repetition or other configuration parameters thereof) associated with the beam search for the Rotman lens of the backscatter device. In some aspects, such as examples where the network entity performs the measurements associated with the beam sweeping and the beam search (e.g., as in the example of FIG. 9), the systems and techniques can be configured to support feedback from the network entity to the backscatter device indicative of selection of a proper one or more (or a group of) beams of the plurality of beams 990 and/or one or more (or a group of) beam ports of the plurality of beam ports 910. For instance, in the example of a binary search used for the beam learning and/or beam selection, the feedback transmitted between the network entity and the AIoT tag or other backscatter device including the Rotman lens 920 can be indicated using one bit (e.g., one-bit feedback for each iteration or round of the binary search).

In some cases, an AIoT tag or backscatter device including a Rotman lens (e.g., an AIoT tag or backscatter device including a Rotman lens such as the Rotman lens 820 of FIG. 8, the Rotman lens 920 of FIG. 9, etc.) can be configured to support different combinations and/or configurations of various groups, combinations, subsets, etc., of the respective beam ports included in the plurality of beam ports 810 of FIG. 8 or 910 of FIG. 9, respectively. In one illustrative example, the systems and techniques can be configured to provide signaling between the backscatter device and the network entity, where the signaling implements beam indication using a bitmap. For instance, beam indication using a bitmap can be implemented based on each bit position of the bitmap being associated with one particular beam port or a set of connected beam ports (e.g., a subset of the plurality of beam ports 810 or 910 of FIG. 8 or 9, respectively).

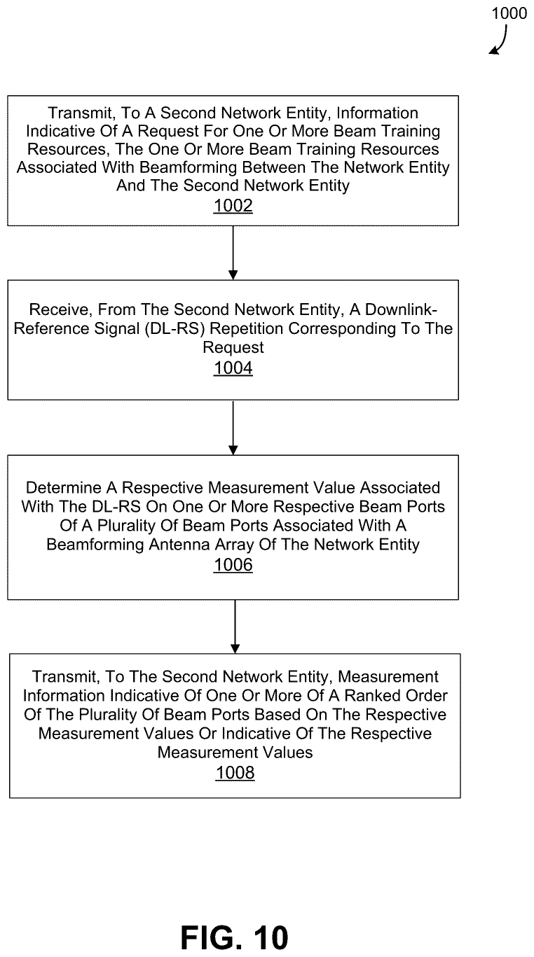

FIG. 10 is a flowchart diagram illustrating an example of a process 1000 for wireless communications. The process 1000 may be performed by a network entity such as a UE (e.g., including any of the UEs of any of FIGS. 1-4). In some aspects, the process 1000 can be implemented by a backscatter device, such as an AIoT tag or other passive or semi-passive AIoT device, or a component or system (e.g., a chipset, one or more processors such as one or more microprocessors, graphics processing units (GPUs), digital signal processors (DSPs), central processing units (CPUs), neural processing units (NPUs), neural signal processors (NSPs), etc., any combination thereof, and/or other component or system) of the backscatter device. For instance, the process 1000 can be implemented by a network entity or other backscatter device that is the same as or similar to the backscatter device 500 of FIG. 5, the backscattering (e.g., AIoT) device 602 of FIG. 6, the backscatter device 800 of FIG. 8, the backscatter device 900 of FIG. 9, etc.

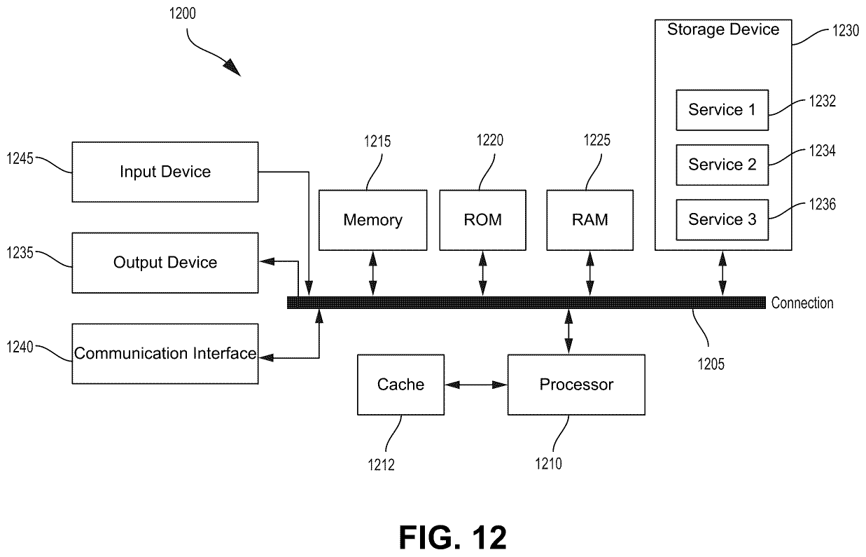

The operations of the process 1000 may be implemented as software components that are executed and run on one or more processors (e.g., processor 1210 of FIG. 12 or other processor(s)). Further, the transmission and reception of signals by the backscatter device in the process 1000 may be enabled, for example, by one or more antennas and/or one or more transceivers (e.g., antenna(s) and/or wireless transceiver(s) of any of FIGS. 1-9, etc.).

At block 1002, the network entity (or component thereof) can transmit, to a second network entity, information indicative of a request for one or more beam training resources, the one or more beam training resources associated with beamforming between the network entity and the second network entity. For example, the network entity can be an ambient Internet-of-Things (AIoT) tag or a backscatter user equipment (UE) including a beamforming antenna array. In some cases, a beamforming antenna array of the network entity can be the same as or similar to the beamforming antenna array 850 of FIGS. 8 and/or 950 of FIG. 9. In some examples, the second network entity is a base station, including any of the base stations of any one or more of FIGS. 1-4, etc.

In some cases, the beamforming antenna array of the network entity includes a Rotman lens associated with the plurality of beam ports. For example, the Rotman lens can be the same as or similar to the Rotman lens 820 of FIGS. 8 and/or 920 of FIG. 9. In some examples, the plurality of beam ports can be input ports of the Rotman lens. For instance, the plurality of beam ports can be the same as or similar to the plurality of beam ports 810 of FIGS. 8 and/or 910 of FIG. 9. The plurality of beam ports can be associated with a plurality of beams, such as the plurality of beams 890-1, . . . , 890-6 of FIG. 8 and/or the plurality of beams 990-1, . . . , 990-6 of FIG. 9.

At block 1004, the network entity (or component thereof) can receive, from the second network entity, a downlink-reference signal (DL-RS) repetition corresponding to the request. In some examples, the information indicative of the request for one or more beam training resources is indicative of one or more of a quantity of DL-RS resources or a periodicity of DL-RS resources of the DL-RS repetition. In some cases, the DL-RS repetition comprises a plurality of channel state information-reference signals (CSI-RS).

At block 1006, the network entity (or component thereof) can determine a respective measurement value associated with the DL-RS on one or more respective beam ports of a plurality of beam ports associated with a beamforming antenna array of the network entity.

For instance, the plurality of beam ports can be the same as or similar to the plurality of beam ports 810 of FIGS. 8 and/or 910 of FIG. 9. The plurality of beam ports can be associated with a plurality of beams, such as the plurality of beams 890-1, . . . , 890-6 of FIG. 8 and/or the plurality of beams 990-1, . . . , 990-6 of FIG. 9.

In some cases, the plurality of beam ports are input ports of a Rotman lens included in the beamforming antenna array of the network entity, such as the Rotman lens 820 of FIGS. 8 and/or 920 of FIG. 9. In some cases, to determine the respective measurement value, the network entity is configured to determine a respective reference signal received power (RSRP) value or a respective received signal strength indicator (RSSI) value associated with the DL-RS repetition on the one or more respective beam ports.

In some examples, to determine the respective measurement value, the network entity is configured to: determine a harvested power value or a direct current (DC) voltage value associated with the DL-RS repetition on the one or more respective beam ports. For example, the harvested power value can be associated with energy harvesting performed by the network entity and/or an energy harvester (e.g., such as the energy harvester 530 of the backscatter device 500 of FIG. 5) included in the network entity. In some examples, the respective measurement value can be determined using the power detector 880 of FIG. 8.

In some examples, the network entity is further configured to: transmit, to the second network entity, capability information indicative of a configuration of the plurality of beam ports or a configuration of a Rotman lens included in the beamforming antenna array of the network entity. For instance, the capability information can be indicative of a configuration of the plurality of beam ports 810 of FIGS. 8 and/or 910 of FIG. 9. In some cases, the capability information can be indicative of a configuration of the Rotman lens 820 and/or antenna array 850 of FIG. 8. In some examples, the capability information can be indicative of a configuration of the Rotman lens 920 and/or the antenna array 950 of FIG. 9.

In some cases, the network entity can receive, from the second network entity, a beam sweeping configuration indicative of a configured subset of beam ports of the plurality of beam ports, wherein the beam sweeping configuration is based on the capability information. For instance, the beam sweeping configuration can be indicative of a configured subset of beam ports of the plurality of beam ports 810 of FIGS. 8 and/or 910 of FIG. 9. In some examples, to determine a respective measurement value associated with the DL-RS on the one or more respective beam ports, the network entity is configured to determine a respective measurement value associated with the DL-RS on each beam port of the configured subset of beam ports indicated by the beam sweeping configuration.

At block 1008, the network entity (or component thereof) can transmit, to the second network entity, measurement information indicative of one or more of a ranked order of the plurality of beam ports based on the respective measurement values or indicative of the respective measurement values. In some examples, the measurement information can be determined using the power detector 880 of FIG. 8 and/or the beam sweeping of FIG. 9.

In some cases, the network entity can perform one or more of energy harvesting or backscattering based on a downlink signal received from the second network entity and configured based on the measurement information. In some examples, the network entity is further configured to perform the energy harvesting or backscattering using a selected beam port of the plurality of beam ports, the selected beam port determined based on the measurement information.

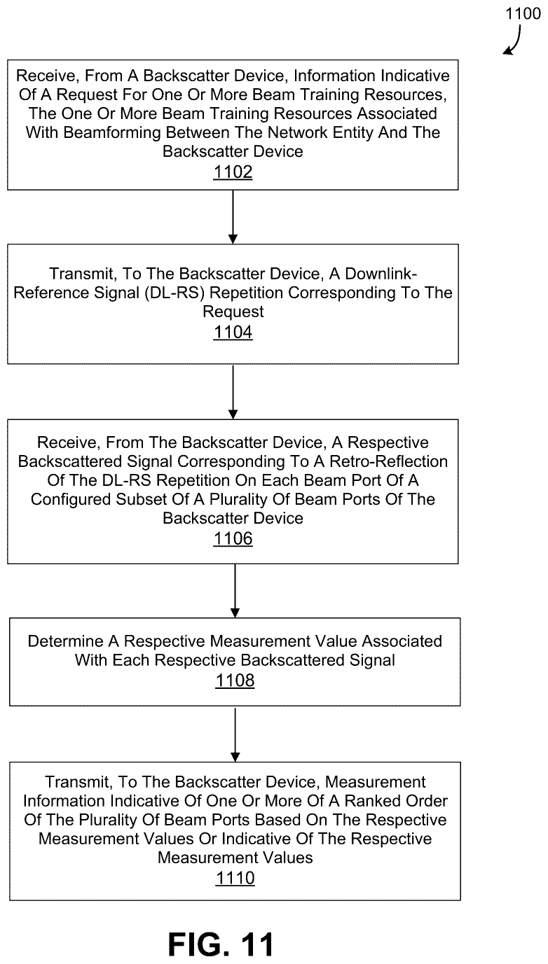

FIG. 11 is a flowchart diagram illustrating an example of a process 1100 for wireless communications. In some examples, the process 1100 may be performed by a network entity or by a component or system (e.g., a chipset, one or more processors such as one or more microprocessors, graphics processing units (GPUs), digital signal processors (DSPs), central processing units (CPUs), neural processing units (NPUs), neural signal processors (NSPs), etc., any combination thereof, and/or other component or system) of the network entity. In some examples, the network entity is a base station (e.g., the base station 102 of FIG. 1 and/or FIG. 2, the disaggregated base station 300 of FIG. 4) or a portion of the base station (e.g., the CU 310, the DU 330, the RU 340, the Near-RT RIC 325, the Non-RT RIC 315, and/or or other portion of the disaggregated base station 300 of FIG. 3), such as a gNB. The network entity or base station used to implement or perform process 1100 can be the same as or similar to any one or more of the various base stations of FIGS. 1-4. In other examples, the network entity can be a UE (e.g., including a non-ambient IoT UE), a repeater node, an IAB node, etc. The operations of the process 1100 may be implemented as software components that are executed and run on one or more processors (e.g., processor 1210 of FIG. 12 or other processor(s)). Further, the transmission and reception of signals by the network entity in the process 1100 may be enabled, for example, by one or more antennas and/or one or more transceivers (e.g., antenna(s) and/or wireless transceiver(s) of any of FIGS. 1-9, etc.).

At block 1102, the network entity (or component thereof) can receive, from a backscatter device, information indicative of a request for one or more beam training resources, the one or more beam training resources associated with beamforming between the network entity and the backscatter device.

In some cases, the backscatter device can be an AIoT tag or other passive or semi-passive AIoT device that is the same as or similar to the backscatter device 500 of FIG. 5, the backscattering (e.g., AIoT) device 602 of FIG. 6, the backscatter device 800 of FIG. 8, the backscatter device 900 of FIG. 9, etc. In some cases, the backscatter device associated with the process 1100 of FIG. 11 can be the same as the network entity used to perform the process 1000 of FIG. 10. In some examples, the network entity used to perform the process 1100 of FIG. 11 can be the same as the second network entity associated with the process 1000 of FIG. 10.

In some examples, the backscatter device is an ambient Internet-of-Things (AIoT) tag or a backscatter user equipment (UE), and wherein a beamforming antenna array of the network entity includes a Rotman lens associated with the plurality of beam ports, and the network entity is a base station. For instance, the network entity can be a base station (e.g., gNB, etc.) and the backscatter device can be an ambient Internet-of-Things (AIoT) tag or a backscatter user equipment (UE). The Rotman lens can be the same as or similar to the Rotman lens 820 of FIGS. 8 and/or 920 of FIG. 9.

In some examples, a plurality of beam ports can be input ports of the Rotman lens. For instance, the plurality of beam ports can be the same as or similar to the plurality of beam ports 810 of FIGS. 8 and/or 910 of FIG. 9. The plurality of beam ports can be associated with a plurality of beams, such as the plurality of beams 890-1, . . . , 890-6 of FIG. 8 and/or the plurality of beams 990-1, . . . , 990-6 of FIG. 9. The Rotman lens can be associated with and/or the backscatter device can include a beamforming antenna array. In some cases, a beamforming antenna array of the network entity can be the same as or similar to the beamforming antenna array 850 of FIGS. 8 and/or 950 of FIG. 9.

At block 1104, the network entity (or component thereof) can transmit, to the backscatter device, a downlink-reference signal (DL-RS) repetition corresponding to the request. For instance, the DL-RS repetition can be the same as or similar to the DL-RS repetition associated with block 1004 of FIG. 10.

At block 1106, the network entity (or component thereof) can receive, from the backscatter device, a respective backscattered signal corresponding to a retro-reflection of the DL-RS repetition on each beam port of a configured subset of a plurality of beam ports of the backscatter device.

For example, the retro-reflection of the DL-RS repetition can be transmitted on each beam port of a configured subset of the plurality of beam ports 810 of the backscatter device 800 of FIG. 8 and/or a configured subset of the plurality of beam ports 910 of the backscatter device 900 of FIG. 9.

At block 1108, the network entity (or component thereof) can determine a respective measurement value associated with each respective backscattered signal.

For instance, to determine a respective measurement value associated with each respective backscattered signal, the network entity can be configured to measure a plurality of backscatter signals corresponding to a retro-reflection of the DL-RS repetition by each beam port of the configured subset. In some examples, each backscatter signal of the plurality of backscatter signals corresponds to a different measurement occasion associated with the DL-RS repetition. For instance, backscatter signals can be received as a retro-reflection of the DL-RS repetition by each of beam ports #6 and #3 of the plurality of beam ports 810 of the backscatter device 800 of FIG. 8.

In a first measurement occasion associated with the DL-RS repetition, the network entity can receive a first backscatter signal on beam port #6, in a second measurement occasion the network entity can receive a second backscatter signal on beam port #3, in a third measurement occasion the network entity can receive a third backscatter signal on beam port #6, in a fourth measurement the network entity can receive a fourth backscatter signal on beam port #3, etc.

In some cases, to determine the respective measurement value associated with each backscattered signal, the network entity is configured to determine one or more of a reference signal received power (RSRP) value, a signal-to-noise ratio (SNR) value, or a signal-to-interference-to-noise ratio (SINR) value associated with each backscattered signal.

At block 1110, the network entity (or component thereof) can transmit, to the backscatter device, measurement information indicative of one or more of a ranked order of the plurality of beam ports based on the respective measurement values or indicative of the respective measurement values.

For instance, the measurement information can be indicative of a ranked order the same as or similar to the ranked order associated with block 1008 of FIG. 10, etc. In some cases, the network entity is further configured to receive, from the backscatter device, capability information indicative of a configuration of the plurality of beam ports or a configuration of a Rotman lens included in a beamforming antenna array of the backscatter device. In some examples, the network entity can be configured to the backscatter device, a beam sweeping configuration indicative of the configured subset of beam ports of the plurality of beam ports, wherein the beam sweeping configuration is based on the capability information.

In some instances, the network entity is further configured to transmit, to the backscatter device, one or more downlink signals configured for beamformed energy harvesting or beamformed backscattering by the backscatter device, the one or more downlink signals configured based on beamforming information determined from the measurement information. In some cases, the network entity is further configured to receive, from the backscatter device, a backscattered signal comprising a retro-reflection of at least a portion of the one or more downlink signals, wherein the backscattered signal and the one or more downlink signals are associated with the same beam port of the plurality of beam ports of the backscatter device.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), neural processing units (NPUs), neural signal processors (NSPs), and/or other suitable electronic circuits), and/or may include and/or be implemented using computer software, firmware, or any combination thereof, to perform the various operations described herein.

The process 1000 and the process 1100 are illustrated as logical flow diagrams, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 1000, the process 1100, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a diagram illustrating an example of a system for implementing certain aspects of the present technology. In particular, FIG. 12 illustrates an example of computing system 1200, which may be for example any computing device making up internal computing system, a remote computing system, a camera, or any component thereof in which the components of the system are in communication with each other using connection 1205. Connection 1205 may be a physical connection using a bus, or a direct connection into processor 1210, such as in a chipset architecture. Connection 1205 may also be a virtual connection, networked connection, or logical connection.

In some aspects, computing system 1200 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 may include a cache 1215 of high-speed memory connected directly with, in close proximity to, or integrated as part of processor 1210.

Processor 1210 may include any general-purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which may represent any number of input mechanisms, such as a microphone for speech, a touch-sensitive screen for gesture or graphical input, keyboard, mouse, motion input, speech, etc. Computing system 1200 may also include output device 1235, which may be one or more of a number of output mechanisms. In some instances, multimodal systems may enable a user to provide multiple types of input/output to communicate with computing system 1200.

Computing system 1200 may include communications interface 1240, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1230 may include software services, servers, services, etc., that when the code that defines such software is executed by the processor 1210, it causes the system to perform a function. In some aspects, a hardware service that performs a particular function may include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“>”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A network entity for wireless communication, comprising: at least one memory; and at least one processor coupled to the at least one memory, wherein the network entity is configured to: transmit, to a second network entity, information indicative of a request for one or more beam training resources, the one or more beam training resources associated with beamforming between the network entity and the second network entity; receive, from the second network entity, a downlink-reference signal (DL-RS) repetition corresponding to the request; determine a respective measurement value associated with the DL-RS on one or more respective beam ports of a plurality of beam ports associated with a beamforming antenna array of the network entity; and transmit, to the second network entity, measurement information indicative of one or more of a ranked order of the plurality of beam ports based on the respective measurement values or indicative of the respective measurement values.

Aspect 2. The network entity of Aspect 1, wherein the network entity is further configured to: perform one or more of energy harvesting or backscattering based on a downlink signal received from the second network entity and configured based on the measurement information.

Aspect 3. The network entity of Aspect 2, wherein the network entity is further configured to: perform the energy harvesting or backscattering using a selected beam port of the plurality of beam ports, the selected beam port determined based on the measurement information.

Aspect 4. The network entity of any of Aspects 1 to 3, wherein, to determine the respective measurement value, the network entity is configured to: determine a respective reference signal received power (RSRP) value or a respective received signal strength indicator (RSSI) value associated with the DL-RS repetition on the one or more respective beam ports.

Aspect 5. The network entity of any of Aspects 1 to 4, wherein, to determine the respective measurement value, the network entity is configured to: determine a harvested power value or a direct current (DC) voltage value associated with the DL-RS repetition on the one or more respective beam ports.

Aspect 6. The network entity of any of Aspects 1 to 5, wherein the plurality of beam ports are input ports of a Rotman lens included in the beamforming antenna array of the network entity.

Aspect 7. The network entity of any of Aspects 1 to 6, wherein: the network entity is an ambient Internet-of-Things (AIoT) tag or a backscatter user equipment (UE), and wherein the beamforming antenna array of the network entity includes a Rotman lens associated with the plurality of beam ports; and the second network entity is a base station.

Aspect 8. The network entity of any of Aspects 1 to 7, wherein the information indicative of the request for one or more beam training resources is indicative of one or more of a quantity of DL-RS resources or a periodicity of DL-RS resources of the DL-RS repetition.

Aspect 9. The network entity of any of Aspects 1 to 8, wherein the DL-RS repetition comprises a plurality of channel state information-reference signals (CSI-RS).

Aspect 10. The network entity of any of Aspects 1 to 9, wherein the network entity is further configured to: transmit, to the second network entity, capability information indicative of a configuration of the plurality of beam ports or a configuration of a Rotman lens included in the beamforming antenna array of the network entity; and receive, from the second network entity, a beam sweeping configuration indicative of a configured subset of beam ports of the plurality of beam ports, wherein the beam sweeping configuration is based on the capability information.

Aspect 11. The network entity of Aspect 10, wherein, to determine a respective measurement value associated with the DL-RS on the one or more respective beam ports, the network entity is configured to: determine a respective measurement value associated with the DL-RS on each beam port of the configured subset of beam ports indicated by the beam sweeping configuration.

Aspect 12. A method for wireless communication at a network entity, comprising: transmitting, to a second network entity, information indicative of a request for one or more beam training resources, the one or more beam training resources associated with beamforming between the network entity and the second network entity; receiving, from the second network entity, a downlink-reference signal (DL-RS) repetition corresponding to the request; determining a respective measurement value associated with the DL-RS on one or more respective beam ports of a plurality of beam ports associated with a beamforming antenna array of the network entity; and transmitting, to the second network entity, measurement information indicative of one or more of a ranked order of the plurality of beam ports based on the respective measurement values or indicative of the respective measurement values.

Aspect 13. The method of Aspect 12, further comprising: performing one or more of energy harvesting or backscattering based on a downlink signal received from the second network entity and configured based on the measurement information.

Aspect 14. The method of Aspect 13, further comprising: performing the energy harvesting or backscattering using a selected beam port of the plurality of beam ports, the selected beam port determined based on the measurement information.

Aspect 15. The method of any of Aspects 12 to 14, wherein determining the respective measurement value comprises: determining a respective reference signal received power (RSRP) value or a respective received signal strength indicator (RSSI) value associated with the DL-RS repetition on the one or more respective beam ports.

Aspect 16. The method of any of Aspects 12 to 15, wherein determining the respective measurement value comprises: determining a harvested power value or a direct current (DC) voltage value associated with the DL-RS repetition on the one or more respective beam ports.

Aspect 17. The method of any of Aspects 12 to 16, wherein the plurality of beam ports are input ports of a Rotman lens included in the beamforming antenna array of the network entity.

Aspect 18. The method of any of Aspects 12 to 17, wherein: the network entity is an ambient Internet-of-Things (AIoT) tag or a backscatter user equipment (UE), and wherein the beamforming antenna array of the network entity includes a Rotman lens associated with the plurality of beam ports; and the second network entity is a base station.

Aspect 19. The method of any of Aspects 12 to 18, wherein the information indicative of the request for one or more beam training resources is indicative of one or more of a quantity of DL-RS resources or a periodicity of DL-RS resources of the DL-RS repetition.

Aspect 20. The method of any of Aspects 12 to 19, wherein the DL-RS repetition comprises a plurality of channel state information-reference signals (CSI-RS).

Aspect 21. The method of any of Aspects 12 to 20, further comprising: transmitting, to the second network entity, capability information indicative of a configuration of the plurality of beam ports or a configuration of a Rotman lens included in the beamforming antenna array of the network entity; and receiving, from the second network entity, a beam sweeping configuration indicative of a configured subset of beam ports of the plurality of beam ports, wherein the beam sweeping configuration is based on the capability information.

Aspect 22. The method of Aspect 21, wherein determining a respective measurement value associated with the DL-RS on the one or more respective beam ports comprises: determining a respective measurement value associated with the DL-RS on each beam port of the configured subset of beam ports indicated by the beam sweeping configuration.

Aspect 23. A network entity for wireless communication, comprising: at least one memory; and at least one processor coupled to the at least one memory, wherein the network entity is configured to: receive, from a backscatter device, information indicative of a request for one or more beam training resources, the one or more beam training resources associated with beamforming between the network entity and the backscatter device; transmit, to the backscatter device, a downlink-reference signal (DL-RS) repetition corresponding to the request; receive, from the backscatter device, a respective backscattered signal corresponding to a retro-reflection of the DL-RS repetition on each beam port of a configured subset of a plurality of beam ports of the backscatter device; determine a respective measurement value associated with each respective backscattered signal; and transmit, to the backscatter device, measurement information indicative of one or more of a ranked order of the plurality of beam ports based on the respective measurement values or indicative of the respective measurement values.

Aspect 24. The network entity of Aspect 23, wherein the network entity is further configured to: receive, from the backscatter device, capability information indicative of a configuration of the plurality of beam ports or a configuration of a Rotman lens included in a beamforming antenna array of the backscatter device; and transmit, to the backscatter device, a beam sweeping configuration indicative of the configured subset of beam ports of the plurality of beam ports, wherein the beam sweeping configuration is based on the capability information.

Aspect 25. The network entity of any of Aspects 23 to 24, wherein, to determine a respective measurement value associated with each respective backscattered signal, the network entity is configured to: measure a plurality of backscatter signals corresponding to a retro-reflection of the DL-RS repetition by each beam port of the configured subset, wherein each backscatter signal of the plurality of backscatter signals corresponds to a different measurement occasion associated with the DL-RS repetition.

Aspect 26. The network entity of any of Aspects 23 to 25, wherein the network entity is further configured to: transmit, to the backscatter device, one or more downlink signals configured for beamformed energy harvesting or beamformed backscattering by the backscatter device, the one or more downlink signals configured based on beamforming information determined from the measurement information.

Aspect 27. The network entity of Aspect 26, wherein the network entity is further configured to: receive, from the backscatter device, a backscattered signal comprising a retro-reflection of at least a portion of the one or more downlink signals, wherein the backscattered signal and the one or more downlink signals are associated with the same beam port of the plurality of beam ports of the backscatter device.

Aspect 28. The network entity of any of Aspects 23 to 27, wherein, to determine the respective measurement value associated with each backscattered signal, the network entity is configured to: determine one or more of a reference signal received power (RSRP) value, a signal-to-noise ratio (SNR) value, or a signal-to-interference-to-noise ratio (SINR) value associated with each backscattered signal.

Aspect 29. The network entity of any of Aspects 23 to 28, wherein the backscatter device is an ambient Internet-of-Things (AIoT) tag or a backscatter user equipment (UE), and wherein a beamforming antenna array of the network entity includes a Rotman lens associated with the plurality of beam ports.

Aspect 30. The network entity of any of Aspects 23 to 29, wherein the network entity is a base station.

Aspect 31. A method for wireless communication at a network entity, comprising: receiving, from a backscatter device, information indicative of a request for one or more beam training resources, the one or more beam training resources associated with beamforming between the network entity and the backscatter device; transmitting, to the backscatter device, a downlink-reference signal (DL-RS) repetition corresponding to the request; receiving, from the backscatter device, a respective backscattered signal corresponding to a retro-reflection of the DL-RS repetition on each beam port of a configured subset of a plurality of beam ports of the backscatter device; determining a respective measurement value associated with each respective backscattered signal; and transmitting, to the backscatter device, measurement information indicative of one or more of a ranked order of the plurality of beam ports based on the respective measurement values or indicative of the respective measurement values.

Aspect 32. The method of Aspect 31, further comprising: receiving, from the backscatter device, capability information indicative of a configuration of the plurality of beam ports or a configuration of a Rotman lens included in a beamforming antenna array of the backscatter device; and transmitting, to the backscatter device, a beam sweeping configuration indicative of the configured subset of beam ports of the plurality of beam ports, wherein the beam sweeping configuration is based on the capability information.

Aspect 33. The method of any of Aspects 31 to 32, wherein determining a respective measurement value associated with each respective backscattered signal comprises: measuring a plurality of backscatter signals corresponding to a retro-reflection of the DL-RS repetition by each beam port of the configured subset, wherein each backscatter signal of the plurality of backscatter signals corresponds to a different measurement occasion associated with the DL-RS repetition.

Aspect 34. The method of any of Aspects 31 to 33, further comprising: transmitting, to the backscatter device, one or more downlink signals configured for beamformed energy harvesting or beamformed backscattering by the backscatter device, the one or more downlink signals configured based on beamforming information determined from the measurement information.

Aspect 35. The method of any of Aspects 31 to 34, further comprising: receiving, from the backscatter device, a backscattered signal comprising a retro-reflection of at least a portion of the one or more downlink signals, wherein the backscattered signal and the one or more downlink signals are associated with the same beam port of the plurality of beam ports of the backscatter device.

Aspect 36. The method of any of Aspects 31 to 35, wherein determining the respective measurement value associated with each backscattered signal comprises: determining one or more of a reference signal received power (RSRP) value, a signal-to-noise ratio (SNR) value, or a signal-to-interference-to-noise ratio (SINR) value associated with each backscattered signal.

Aspect 37. The method of any of Aspects 31 to 36, wherein the backscatter device is an ambient Internet-of-Things (AIoT) tag or a backscatter user equipment (UE), and wherein a beamforming antenna array of the network entity includes a Rotman lens associated with the plurality of beam ports.

Aspect 38. The method of any of Aspects 31 to 37, wherein the network entity is a base station.

Aspect 39. A non-transitory computer-readable storage medium comprising instructions stored thereon which, when executed by at least one processor, causes the at least one processor to perform operations according to any of Aspects 1 to 22.

Aspect 40. A non-transitory computer-readable storage medium comprising instructions stored thereon which, when executed by at least one processor, causes the at least one processor to perform operations according to any of Aspects 23 to 38.

Aspect 41. An apparatus for wireless communications comprising one or more means for performing operations according to any of Aspects 1 to 22.

Aspect 42. An apparatus for wireless communications comprising one or more means for performing operations according to any of Aspects 23 to 38.

What is claimed is:

1. A network entity for wireless communication, comprising:
at least one memory; and
at least one processor coupled to the at least one memory, wherein the network entity is configured to:
transmit, to a second network entity, information indicative of a request for one or more beam training resources, the one or more beam training resources associated with beamforming between the network entity and the second network entity;
receive, from the second network entity, a downlink-reference signal (DL-RS) repetition corresponding to the request;
determine a respective measurement value associated with the DL-RS on one or more respective beam ports of a plurality of beam ports associated with a beamforming antenna array of the network entity; and
transmit, to the second network entity, measurement information indicative of one or more of a ranked order of the plurality of beam ports based on the respective measurement values or indicative of the respective measurement values.

2. The network entity of claim 1, wherein the network entity is further configured to:
perform one or more of energy harvesting or backscattering based on a downlink signal received from the second network entity and configured based on the measurement information.

3. The network entity of claim 2, wherein the network entity is further configured to:
perform the energy harvesting or backscattering using a selected beam port of the plurality of beam ports, the selected beam port determined based on the measurement information.

4. The network entity of claim 1, wherein, to determine the respective measurement value, the network entity is configured to:
determine a respective reference signal received power (RSRP) value or a respective received signal strength indicator (RSSI) value associated with the DL-RS repetition on the one or more respective beam ports.

5. The network entity of claim 1, wherein, to determine the respective measurement value, the network entity is configured to:
determine a harvested power value or a direct current (DC) voltage value associated with the DL-RS repetition on the one or more respective beam ports.

6. The network entity of claim 1, wherein the plurality of beam ports are input ports of a Rotman lens included in the beamforming antenna array of the network entity.

7. The network entity of claim 1, wherein:
the network entity is an ambient Internet-of-Things (AIoT) tag or a backscatter user equipment (UE), and wherein the beamforming antenna array of the network entity includes a Rotman lens associated with the plurality of beam ports; and
the second network entity is a base station.

8. The network entity of claim 1, wherein the information indicative of the request for one or more beam training resources is indicative of one or more of a quantity of DL-RS resources or a periodicity of DL-RS resources of the DL-RS repetition.

9. The network entity of claim 1, wherein the DL-RS repetition comprises a plurality of channel state information-reference signals (CSI-RS).

10. The network entity of claim 1, wherein the network entity is further configured to:
transmit, to the second network entity, capability information indicative of a configuration of the plurality of beam ports or a configuration of a Rotman lens included in the beamforming antenna array of the network entity; and
receive, from the second network entity, a beam sweeping configuration indicative of a configured subset of beam ports of the plurality of beam ports, wherein the beam sweeping configuration is based on the capability information.

11. The network entity of claim 10, wherein, to determine a respective measurement value associated with the DL-RS on the one or more respective beam ports, the network entity is configured to:
determine a respective measurement value associated with the DL-RS on each beam port of the configured subset of beam ports indicated by the beam sweeping configuration.

12. A method for wireless communication at a network entity, comprising:
transmitting, to a second network entity, information indicative of a request for one or more beam training resources, the one or more beam training resources associated with beamforming between the network entity and the second network entity;
receiving, from the second network entity, a downlink-reference signal (DL-RS) repetition corresponding to the request;
determining a respective measurement value associated with the DL-RS on one or more respective beam ports of a plurality of beam ports associated with a beamforming antenna array of the network entity; and
transmitting, to the second network entity, measurement information indicative of one or more of a ranked order of the plurality of beam ports based on the respective measurement values or indicative of the respective measurement values.

13. A network entity for wireless communication, comprising:
at least one memory; and
at least one processor coupled to the at least one memory, wherein the network entity is configured to:
receive, from a backscatter device, information indicative of a request for one or more beam training resources, the one or more beam training resources associated with beamforming between the network entity and the backscatter device;
transmit, to the backscatter device, a downlink-reference signal (DL-RS) repetition corresponding to the request;
receive, from the backscatter device, a respective backscattered signal corresponding to a retro-reflection of the DL-RS repetition on each beam port of a configured subset of a plurality of beam ports of the backscatter device;
determine a respective measurement value associated with each respective backscattered signal; and
transmit, to the backscatter device, measurement information indicative of one or more of a ranked order of the plurality of beam ports based on the respective measurement values or indicative of the respective measurement values.

14. The network entity of claim 13, wherein the network entity is further configured to:
receive, from the backscatter device, capability information indicative of a configuration of the plurality of beam ports or a configuration of a Rotman lens included in a beamforming antenna array of the backscatter device; and
transmit, to the backscatter device, a beam sweeping configuration indicative of the configured subset of beam ports of the plurality of beam ports, wherein the beam sweeping configuration is based on the capability information.

15. The network entity of claim 13, wherein, to determine a respective measurement value associated with each respective backscattered signal, the network entity is configured to:
measure a plurality of backscatter signals corresponding to a retro-reflection of the DL-RS repetition by each beam port of the configured subset, wherein each backscatter signal of the plurality of backscatter signals corresponds to a different measurement occasion associated with the DL-RS repetition.

16. The network entity of claim 13, wherein the network entity is further configured to:
transmit, to the backscatter device, one or more downlink signals configured for beamformed energy harvesting or beamformed backscattering by the backscatter device, the one or more downlink signals configured based on beamforming information determined from the measurement information.

17. The network entity of claim 16, wherein the network entity is further configured to:
receive, from the backscatter device, a backscattered signal comprising a retro-reflection of at least a portion of the one or more downlink signals, wherein the backscattered signal and the one or more downlink signals are associated with the same beam port of the plurality of beam ports of the backscatter device.

18. The network entity of claim 13, wherein, to determine the respective measurement value associated with each backscattered signal, the network entity is configured to:
determine one or more of a reference signal received power (RSRP) value, a signal-to-noise ratio (SNR) value, or a signal-to-interference-to-noise ratio (SINR) value associated with each backscattered signal.

19. The network entity of claim 13, wherein the backscatter device is an ambient Internet-of-Things (AIoT) tag or a backscatter user equipment (UE), and wherein a beamforming antenna array of the network entity includes a Rotman lens associated with the plurality of beam ports.

20. The network entity of claim 13, wherein the network entity is a base station.
